(19) United States
(12) Patent Application Publication
(10) Pub. No.: US 2023/0046365 A1
(43) Pub. Date: Feb. 16, 2023

(54) TECHNIQUES FOR THREE-DIMENSIONAL ANALYSIS OF SPACES

(71) Applicant: Hill-Rom Services, Inc., Batesville, IN (US)

(72) Inventors: Gene J. Wolfe, Pittsford, NY (US); Susan A. Kayser, Batesville, IN (US); Neal E. Wiggermann, Batesville, IN (US); Sinan Batman, Cary, NC (US); Ibne Soreefan, Union, KY (US)

(21) Appl. No.: 17/886,392

(22) Filed: Aug. 11, 2022

Related U.S. Application Data
(60) Provisional application No. 63/232,623, filed on Aug. 12, 2021.

(51) Int. Cl. G06T 7/70; G06T 17/10; G01B 11/02

(52) U.S. Cl. CPC G06T 7/70; G01B 11/026; G06T 17/10; G06T 2207/10048; G06T 2207/30204

(57) ABSTRACT

An example method includes receiving a 2D image of a 3D space from an optical camera, identifying, in the 2D image. A virtual image generated by an optical instrument refracting and/or reflecting the light is identified. The example method further includes identifying, in the 2D image, a first object depicting a subject disposed in the 3D space from a first direction extending from the optical camera to the subject and identifying, in the virtual image, a second object depicting the subject disposed in the 3D space from a second direction extending from the optical camera to the subject via the optical instrument, the second direction being different than the first direction. A 3D image depicting the subject based on the first object and the second object is generated. Alternatively, a location of the subject in the 3D space is determined based on the first object and the second object.

### CROSS-REFERENCE TO RELATED APPLICATION

This application claims the priority of U.S. Provisional App. No. 63/232,623, which was filed on Aug. 12, 2021 and is incorporated by reference herein in its entirety.

### TECHNICAL FIELD

This application relates generally to techniques for enhancing the field-of-view (FOV) of a two-dimensional (2D) camera using optical instruments, as well as techniques for generating three-dimensional (3D) images of 3D spaces using a single 2D camera.

### BACKGROUND

In recent years, there has been an increasing interest in three-dimensional (3D) imaging. According to particular examples, 3D imaging is helpful in clinical environments for monitoring various devices and equipment moved throughout the environments, as well as for monitoring individuals in the environments. For instance, 3D imaging can be used to track the location of a patient within a clinical environment.

Conventional 3D imaging techniques, however, can be prohibitively expensive. The cost of a depth camera or other type of conventional 3D imaging device can exceed the cost of a two-dimensional (2D) camera by several orders of magnitude. The significant cost of 3D imaging devices has prevented widespread adoption of 3D imaging in clinical environments.

### SUMMARY

Various implementations of the present disclosure relate to techniques for achieving 3D imaging using a single 2D camera. According to some examples, a 2D camera is configured to capture images of a 3D space. The images may depict one or more optical instruments disposed in the 3D space. The optical instruments are configured to reflect and/or refract light, thereby generating virtual images of the 3D space that are included in the images captured by the 2D camera. The virtual images may depict the 3D space from different angles than the 2D camera, such that the images captured by the 2D camera and the virtual images collectively represent the 3D space from multiple directions. An imaging system, which can be implemented by one or more computing devices, may be configured to generate a 3D image of the 3D space based on the 2D images captured directly by the 2D camera as well as the virtual images generated by the optical instrument(s). For instance, the imaging system may be configured to generate a 3D point cloud of the 3D space.

In some cases, the position and/or orientation of each optical instrument can be adjusted over time. For example, the orientation of an optical instrument can be adjusted so that the optical instrument is configured to generate a virtual image of a blind spot of a previous field-of-view (FOV) of the 2D camera. The blind spot may be a region of the 3D space that is blocked from view of the 2D camera by an opaque object (e.g., a medical device). The position of a given optical instrument may be adjusted manually by a user and/or automatically by the imaging system, in various implementations.

According to some examples, the imaging system may further identify, track, and analyze subjects within the 3D space. In some cases, the imaging system may identify individuals (e.g., patients, care providers, etc.), medical devices (e.g., hospital beds, vital sign monitors, etc.), or other objects disposed in the 3D space. According to various examples, the imaging system is configured to track subjects moving throughout the 3D space based on multiple images of the 3D space captured at different times. In particular implementations, the imaging system is configured to identify a risk and/or condition to a patient based on analyzing the 3D or 2D images of the 3D space. For example, the imaging system may be configured to track the posture of a patient over time and may be able to assess risks to the patient based on the posture. Because the imaging system may be able to discern the 3D position and orientation of the patient, the imaging system may determine the posture of the patient with enhanced accuracy.

The imaging system may further rely on other factors to accurately identify the position of subjects in the 3D space. In some cases, a subject may display or otherwise be associated with one or more visual markers, such as barcodes (e.g., QR codes and/or ArUco codes). The imaging system may determine the position and/or orientation of the subject based on depictions of the visual markers in the captured images. In some implementations, the 2D camera may obtain multiple images of the subject at different focal lengths. The imaging system may infer the distance between the camera and the subject by determining the focal length associated with the highest sharpness depiction of the subject in the images.

Various examples described herein address specific problems in the technical field of computer-based imaging. The present disclosure describes various techniques for achieving 3D imaging using a single 2D camera, which reduces the cost of 3D imaging for consumers. Furthermore, the present disclosure describes techniques for enhancing the FOV of a single camera, thereby enabling a single camera to detect light from around corners and/or behind opaque objects that would otherwise block the FOV of the camera. As a result of these and other enhancements described herein, the present disclosure provides various improvements to the technical field of computer-based imaging.

### DESCRIPTION OF THE FIGURES

The following figures, which form a part of this disclosure, are illustrative of described technology and are not meant to limit the scope of the claims in any manner.

FIG. 1 illustrates an example environment for monitoring a 3D space using 2D imaging.

FIG. 2 illustrates an environment including a camera monitoring a room, wherein the camera has a limited FOV.

FIGS. 3A and 3B illustrate examples of environments and including optical instruments configured to increase the apparent FOV of the camera.

FIGS. 4A to 4C illustrate views of an example optical instrument.

FIGS. 5A and 5B illustrate examples of an optical instrument with a curved reflective surface.

FIG. 6 illustrates an example environment for estimating depth information using 2D imaging.

FIGS. 7A and 7B illustrate examples of a 3D patient pose determined by an imaging system.

FIG. 8 illustrates an example process for generating a 3D image of a space based on a 2D image of the space.

FIG. 9 illustrates an example process for estimating a pose of a patient based on one or more 2D images of the patient.

FIG. 10 illustrates at least one example device configured to enable and/or perform the some or all of the functionality discussed herein.

### DETAILED DESCRIPTION

Various implementations of the present disclosure will be described in detail with reference to the drawings, wherein like reference numerals present like parts and assemblies throughout the several views. Additionally, any samples set forth in this specification are not intended to be limiting and merely set forth some of the many possible implementations.

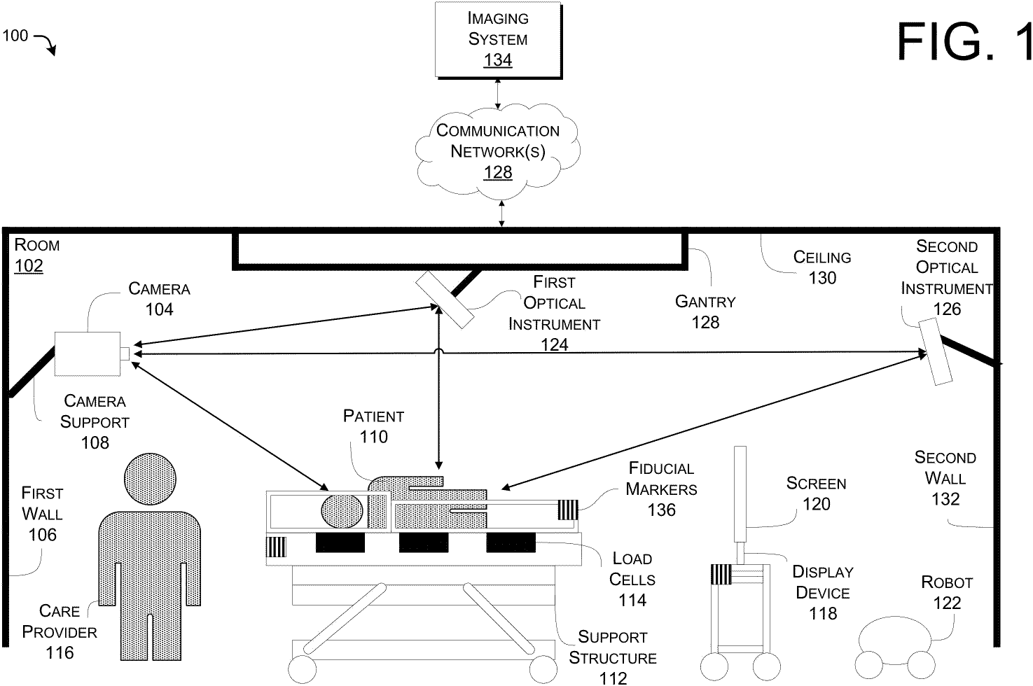

FIG. 1 illustrates an example environment 100 for monitoring a 3D space using 2D imaging. In particular, the environment 100 includes a room 102 that is monitored by a camera 104. The room 102 illustrated in FIG. 1 is a patient room in a clinical setting, such as a clinic, hospital, or other healthcare facility; however, implementations are not so limited. In some implementations, the camera 104 is configured to monitor a room in a school, building, factory, transit station, or some other indoor space. In some cases, the camera 104 is configured to monitor an outdoor space, such as a playground, a sports field, or a transmit stop.

In various implementations, the camera 104 is a 2D camera configured to generate 2D images depicting the room 102. The camera 104 may include a radar sensor, an infrared (IR) camera, a visible light camera, a depth-sensing camera, or any combination thereof. In various cases, the camera 104 includes one or more photosensors configured to detect light. For example, the photosensor(s) detect visible and/or IR light. In various implementations, the camera 104 includes further circuitry (e.g., an analog-to-digital converter (ADC), a processor, etc.) configured to generate digital data representative of the detected light. This digital data is an image, in various cases. As used herein, the term “image,” and its equivalents, refers to a visual representation that includes multiple pixels or voxels. A “pixel” is a datum representative of a discrete area. A “voxel” is a datum representative of a discrete volume. A 2D image includes pixels defined in a first direction (e.g., a height) and a second direction (e.g., a width), for example. A 3D image includes voxels defined in a first direction (e.g., a height), a second direction (e.g., a width), and a third direction (e.g., a depth), for example. In various implementations, the camera 104 is configured to capture a video including multiple images of the room 102, wherein the images can also be referred to as “frames.”

The images captured by the camera 104 may include one or more objects. As used herein, the term “object,” and its equivalents, may refer to a portion of an image that can be interpreted as a single unit and which depicts a single subject depicted in the image. Examples of subjects include machines, devices, equipment, as well as individuals (e.g., humans or other animals) depicted in the images. In some implementations, an object is a portion of a subject that is depicted in the images. For example, a head, a trunk, or a limb of an individual depicted in the images can be an object.

The camera 104 is mounted on a first wall 106 of the room 102 via a camera support 108. In various examples, the camera 104 has an FOV that encompasses a portion of the room 102 at a given time. The camera support 108 may be articulatable, such that it can change the orientation of the camera 104 and thereby adjust the FOV of the camera 104. In some implementations, the camera 104 is configured to narrow or widen the FOV. Further, in some cases, the camera 104 has a zoom in/out functionality. For example, the camera 104 includes one or more lenses whose positions may be adjusted, thereby changing a focal length of the camera 104.

A patient 110 is disposed inside of the room 102. In various cases, the patient 110 is assigned or otherwise associated with the room 102. For example, the patient 110 may at least temporarily reside in the room 102. In various cases, at least some of the images captured by the camera 104 may depict the patient 110. In particular cases, the room 102 may include multiple patients including the patient 110.

As shown in FIG. 1, the patient 110 is resting on a support structure 112. The support structure 112, for example, may be a hospital bed, a gurney, a chair, or any other structure configure to at least partially support a weight of the patient 110. As used herein, the terms “bed,” “hospital bed,” and their equivalents, can refer to a padded surface configured to support a patient for an extended period of time (e.g., hours, days, weeks, or some other time period). The patient 110 may be laying down on the support structure 112. For example, the patient 110 may be resting on the support structure 112 for at least one hour, at least one day, at least one week, or some other time period. In various examples, the patient 110 and the support structure 112 may be located in the room 102. In some implementations, the support structure 112 includes a mechanical component that can change the angle at which the patient 110 is disposed. According to various examples, the support structure 112 further includes a sensor that detects the angle (e.g., with respect to gravity or the floor) at which the support structure 112 and/or the patient 102 is disposed. In some cases, the support structure 112 includes padding to distribute the weight of the patient 110 on the support structure 112. According to various implementations, the support structure 112 can include vital sign monitors configured to output alarms or otherwise communicate vital signs of the patient 110 to external observers (e.g., care providers, visitors, and the like). The support structure 112 may include railings that prevent the patient 110 from sliding off of a resting surface of the support structure 112. The railings may be adjustable, in some cases. According to some examples, the support structure 112 includes a sensor that detects whether the railings are in a position that prevents the patient 110 from sliding off the resting surface or in an inactive position that enables the patient 110 to freely slide off of the resting surface of the support structure 112.

In various examples, the support structure 112 includes one or more sensors. For instance, the support structure 112 may include one or more load cells 114. The load cell(s) 114 may be configured to detect a pressure on the support structure 112. In various cases, the load cell(s) 114 can include one or more strain gauges, one or more piezoelectric load cells, a capacitive load cell, an optical load cell, any device configured to output a signal indicative of an amount of pressure applied to the device, or a combination thereof. For example, the load cell(s) 114 may detect a pressure (e.g., weight) of the patient 110 on the support structure 112. In some cases, the support structure 112 includes multiple load cells that respectively detect different pressures on the support structure 112 in different positions along the support structure 112. In some instances, the support structure 112 includes four load cells arranged at four corners of a resting surface of the support structure 112, which respectively measure the pressure of the patient 110 on the support structure 112 at the four corners of the support structure 112. The resting surface, for instance, can be a surface in which the patient 110 contacts the support structure 112, such as a top surface of the support structure 112.

The support structure 112 may include one or moisture sensors. The moisture sensor(s) may be configured to measure a moisture on a surface (e.g., the resting surface) of the support structure 112. For example, the moisture sensor(s) can include one or more capacitance sensors, one or more resistance sensors, one or more thermal conduction sensors, or a combination thereof. In some cases, the moisture sensor(s) include one or more fiber sheets configured to propagate moisture to the moisture sensor(s). In some cases, the moisture sensor(s) can detect the presence or absence of moisture (e.g., sweat or other bodily fluids) disposed between the support structure 112 and the patient 110.

In various examples, the support structure 112 can include one or more temperature sensors. The temperature sensor(s) may be configured to detect a temperature of at least one of the patient 110, the support structure 112, or the room 102. In some cases, the temperature sensor(s) includes one or more thermistors, one or more thermocouples, one or more resistance thermometers, one or more Peltier sensors, or a combination thereof.

The support structure 112 may include one or more cameras. For instance, the camera 104 be part of the support structure 112. The camera(s) may be configured to capture images of the patient 110, the support structure 112, the room 102, or a combination thereof. In various cases, the camera(s) may include radar sensors, infrared cameras, visible light cameras, depth-sensing cameras, or any combination thereof. In some examples, infrared images may indicate, for instance, a temperature profile of the patient 110 and/or the support structure 112. Thus, the camera(s) may be a type of temperature sensor. In addition, the images may indicate a position of the patient 110 and/or the support structure 112, even in low-visible-light conditions. For example, the infrared images may capture a position of the patient 110 during a night environment without ambient lighting in the vicinity of the patient 110 and/or the support structure 112. In some cases, the camera(s) may include one or more infrared video cameras. The camera(s) may include at least one depth-sensing camera configured to generate a volumetric image of the patient 110, the support structure 112, and the ambient environment. According to various implementations, the images and/or videos captured by the camera(s) are indicative of a position and/or a movement of the patient 110 over time.

According to some examples, the support structure 112 can include one or more video cameras. The video camera(s) may be configured to capture videos of the patient 110, the support structure 112, the room 102, an entrance to the room 102, an entrance to a bathroom adjacent to the room 102, or a combination thereof. The videos may include multiple images of the patient 110 and/or the support structure 112. Thus, the videos captured by the video camera(s) may be indicative of a position and/or movement of the patient 110 over time. In some examples, the video camera(s) capture visible light videos, changes in radar signals over time, infrared videos, or any combination thereof. According to some implementations, the camera 104 is mounted on or otherwise integrated with the support structure 112. That is, the camera 104 may be one of the camera(s) and/or video camera(s) of the support structure 112.

In some examples, the support structure 112 can include one or more microphones configured to capture audio signals output by the patient 110, the support structure 112, and/or the ambient environment. The audio signals captured by the microphone(s) may be indicative of a position and/or movement of the patient 110 over time. In particular cases, the microphone(s) are integrated within the camera(s) and/or video camera(s).

In some examples, the support structure 112 includes a head rail and a foot rail. The camera(s) and/or video camera(s), for instance, are mounted on the head rail, the foot rail, an extension (e.g., a metal or polymer structure) attached to the head rail or the foot rail, or any combination thereof. In various implementations, the camera(s) and/or video camera(s) are attached to a wall or ceiling of the room containing the support structure 116. In some examples, the camera(s) and/or video camera(s) are attached to a cart or other object that is located in the vicinity of the support structure 112.

In various cases, the sensors (e.g., the load cell(s) 114, the temperature sensor(s), the camera(s), the video camera(s), the microphone, or any combination thereof) of the support structure 112 are configured to monitor one or more parameters of the patient 110 and to generate sensor data associated with the patient 110. In various cases, the sensors convert analog signals (e.g., pressure, moisture, temperature, light, electric signals, sound waves, or any combination thereof) into digital data that is indicative of one or more parameters of the patient 104. As used herein, the terms “parameter,” “patient parameter,” and their equivalents, can refer to a condition of an individual and/or the surrounding environment. In this disclosure, a parameter of the patient 10 can refer to a position of the patient 110, a movement of the patient 110 over time (e.g., mobilization of the patient 110 on and off of the support structure 112), a pressure between the patient 110 and an external object (e.g., the support structure 112), a moisture level between the patient and the support structure 112, a temperature of the patient 110, a vital sign of the patient 110, a nutrition level of the patient 110, a medication administered and/or prescribed to the patient 110, a previous condition of the patient 110 (e.g., the patient was monitored in an ICU, in dialysis, presented in an emergency department waiting room, etc.), circulation of the patient 110 (e.g., restricted blood flow), a pain level of the patient 110, the presence of implantable or semi-implantable devices (e.g., ports, tubes, catheters, other devices, etc.) in contact with the patient 110, a sound emitted by the patient 110, or any combination thereof. In various examples, the load cell(s) 114, the temperature sensor(s), the cameras, the video camera(s), the microphone(s), or a combination thereof, generates sensor data indicative of one or more parameters of the patient 110.

In various examples, a care provider 116 is also located in the room 102. The care provider 116, for example, may be a nurse, a nursing assistant, a physician, a physician’s assistant, a physical therapist, or some other authorized healthcare provider. In various implementations, at least some of the images captured by the camera 104 may depict the care provider 116.

A display device 118 may be present in the room 102. The display device 118 includes a screen 120 configured to display an image. In some cases, the display device 118 is a medical device. For instance, the display device 118 may be a vital sign monitor configured to monitor one or more parameters of the patient 110. In some cases, the display device 118 is a computing device used to access an electronic medical record (EMR) of the patient 110. For instance, the care provider 116 may view EMR data of the patient 110 on the screen 120. The display device 118 may be communicatively coupled to an EMR system (not illustrated) that stores the EMR data and transmits the EMR data to the display device 118 for display. In some cases, the EMR system is instantiated in one or more server computers connected to the display device 118 via at least one wired interface and/or at least one wireless interface.

A robot 122 may also be present in the room 102. In various cases, the robot 122 is mobile. For instance, the robot 122 may include wheels that transport the robot 122 along a floor of the room 102. In various cases, the robot 122 is semi-autonomous, such that the robot 122 is not directly controlled manually by a user. For instance, the robot 122 may include a camera that captures images of the room 102 and a processor that analyzes the images. In some cases, the processor may identify that a subject (e.g., the support structure 112) in the room 102 based on the images. The robot 122 may further include a motor or some other device configured to move the robot 122 (e.g., via the wheels) that is communicatively coupled to the processor. Upon identifying the subject, the processor may cause the robot 122 to move in such a way that avoids the identified subject. The robot 122, in some cases, is configured to clean the room 102, sterilize parts of the room 102 using an ultraviolet (UV) sterilizer, change bedding of the patient 110, lift the patient 110, deliver food to the patient 110, or the like. In some cases, the robot 122 is configured to interact with a subject in the room. For example, the robot 122 may include an articulated arm with a motor that is communicatively coupled to the processor. Upon identifying the subject, the processor may cause the arm of the robot 122 to deliver medication, gather dirty linens, or clean the subject. In various implementations, the robot 122 may identify active and passive elements within the room 102. The robot 122 may navigate itself throughout the room 102 based on identifying subjects within the FOV of its own camera and/or subjects within the FOV (or apparent FOV) of the camera 104.

The FOV of the camera 104 may be limited. For example, the edge of the FOV of the camera 104 may span a particular viewing angle range. In addition, the FOV of the camera 104 may be limited by opaque obstructions in the room 102. For example, the FOV of the camera may omit at least a portion of the display device 118 and the robot 122, because the patient 110 and the support structure 112 obstruct the FOV of the camera 104.

In addition, the 2D images generated by the camera 104 are limited based on the single perspective of the camera 104. Because the camera 104 is configured to perceive light transmitted from positions in the room 102 to the camera 104 position directly, the camera 104 is unable to directly detect light emitted from and/or reflected from surfaces that are not facing the camera 104 during imaging. For instance, the camera 104 is configured obtain a 2D image of the patient 110 from its mounted position on the first wall 106, wherein the 2D image of the patient 110 does not depict the bottom of the feet of the patient 110, which are facing away from the camera 104. Notably, this deficiency would still be relevant if the camera 104 was a depth camera, such as a Kinect® by Microsoft Corporation of Redmond, WA.

Various implementations of the present disclosure increase the FOV and perspectives detected by a single 2D camera, such as the camera 104. A first optical instrument 124 and a second optical instrument 126 are disposed in the room 102. In some implementations, the first optical instrument 124 and the second optical instrument 126 include mirrors configured to reflect light. According to some cases, the first optical instrument 124 and the second optical instrument 126 include one or more lenses and/or prisms configured to refract light. In various implementations, the first optical instrument 124 and the second optical instrument 126 are configured to change the direction of incident light.

The camera 104 is configured to capture a 2D image depicting the first optical instrument 124 and the second optical instrument 126. The first optical instrument 124 produces a first virtual image of the room 102 based on reflecting and/or refracting light. Similarly, the second optical instrument 126 produces a second virtual image of the room 102 based on reflecting and/or refracting light. As used herein, the term “virtual image,” and its equivalents, may refer to a pattern of light that represents a real subject, but wherein the pattern of light is not emanating from the direction of the real subject itself. In various cases, the first virtual image overlays an object representing the first optical instrument 124 in the 2D image and the second virtual image overlays an object representing the second optical instrument 126 in the 2D image.

In the example of FIG. 1, the first optical instrument 124 is attached to a gantry 128, which is mounted on a ceiling 130 of the room 102; the second optical instrument 126 is attached to a second wall 132 of the room 102. In some implementations, a greater or fewer number of optical instruments are present in the room 102. Optical instruments may be mounted or otherwise attached on the first wall 106, the ceiling 130, the second wall 132, other walls of the room 102, a floor of the room 102, a doorway of the room 102, a window of the room 102, subjects (e.g., medical devices) located in the room, or any other suitable fixture. Each optical instrument may generate a respective virtual image of the room 102. In some examples, an optical instrument could be a window of the room 102, such as a reflective window.

In various implementations, the camera 104 transmits the 2D image, which includes the first virtual image and the second virtual image, to an imaging system 134. For example, the camera 104 transmits data representing the 2D image to the imaging system 134 via one or more communication networks 136. As used herein, the term “communication network,” and its equivalents, may refer to at least one device and/or at least one interface over which data can be transmitted between endpoints. For instance, the communication network(s) 136 may represent one or more communication interfaces traversing the communication network(s) 136. Examples of communication networks include at least one wired interface (e.g., an ethernet interface, an optical cable interface, etc.) and/or at least one wireless interface (e.g., a BLUETOOTH interface, a WI-FI interface, a near-field communication (NFC) interface, a Long Term Evolution (LTE) interface, a New Radio (NR) interface, etc.). In some cases, data or other signals are transmitted between elements of FIG. 1 over a wide area network (WAN), such as the Internet. In some cases, the data include one or more data packets (e.g., Internet Protocol (IP) data packets), datagrams, or a combination thereof.

The imaging system 132 is implemented in hardware and/or software. For example, the imaging system 132 includes one or more processors configured to perform various operations. The imaging system 132 may further include memory storing instructions that are executed by the processor(s) for performing the operations. In some cases, the imaging system 132 is implemented on at least one on-premises server located at the clinical setting and/or at least one server located externally from the clinical setting (e.g., a cloud-based network).

The imaging system 132, in various cases, is configured to generate a 3D image of the room 102 based on the 2D image captured by the camera 104. According to various implementations, the imaging system 132 generates a point cloud of the room 102 and/or subjects located within the room 102 based on the 2D image. The imaging system 132 is configured to generate data indicative of the 3D features of the room 102, in various implementations.

In particular examples in which the first optical instrument 124 and the second optical instrument 126 include mirrors, the first virtual image represents a mirror image of the room 102 from the perspective of the first optical instrument 124 and the second virtual image represents a mirror image of the room 102 from the perspective of the second optical instrument 126. Based on these mirror images, as well as the direct representation of the room 102 in 2D image itself, parallax is achieved. Based on the parallax provided by the perspective of the camera 104, the perspective of the first optical instrument 124, and the perspective of the second optical instrument 126, the imaging system 132 may use various image processing techniques to generate the 3D image of the room 102 based on the single 2D image captured by the camera 104.

Furthermore, according to various implementations, the imaging system 134 can increase the FOV of the camera 104 based on the virtual images associated with the first optical instrument 124 and the second optical instrument 126. For example, the camera 104 receives light traveling directly from a head of the patient 110 in a first direction, but the FOV of the camera 104 may exclude light traveling from the fingertips of the patient 110 and the foot of the patient 110. The first optical instrument 124 reflects light from the fingertips of the patient 110 toward the camera 104 in a second direction. The second optical instrument 126 reflects light from the foot of the patient 110 toward the camera 104 in a third direction. Based on the first and second virtual images in the single 2D image, the imaging system 134 can generate an image of the room 102 that depicts the fingertips of the patient 110 and the foot of the patient 110, thereby increasing the FOV of the camera 104.

In various implementations, the imaging system 134 may adjust the camera 104, the first optical instrument 124, and the second optical instrument 126. For example, the imaging system 134 may transmit control signals to one or more actuators coupled to the camera 104, the camera support 108, the first optical instrument 124, the second optical instrument 126, wherein the control signals cause the actuator(s) to adjust a position and/or orientation of at least one of the camera 104, the first optical instrument 124, or the second optical instrument 126. For example, the imaging system 134 may transmit a control signal that causes the first optical instrument 124 to change a position along the gantry 128. In some cases, the imaging system 124 transmits control signals to the first optical instrument 124 and the second optical instrument 126, which cause the first optical instrument 124 and/or the second optical instrument 126 to alter a curvature of a mirror and/or a distance between lenses of the first optical instrument 124 and/or the second optical instrument 126. In some cases, the imaging system 134 analyzes a first image of the room 102, generates the control signal(s) based on the analysis, and identifies a second image of the room 102 once the control signal(s) have caused an adjustment of the camera 104, the first optical instrument 124, the second optical instrument 126, or any combination thereof. This process can be repeated for the purpose of monitoring aspects of the room 102, such as tracking subjects in the room. Alternatively, the camera 104, the first optical instrument 124, and the second optical instrument 126 may be manually adjusted (e.g., by the care provider 116). In some cases, the imaging system 134 can track the position and/or orientation of the first optical instrument 124 and the second optical instrument 126 based on fiducial markers printed on a surface of the first optical instrument 124 and the second optical instrument 126.

According to some cases, the imaging system 134 analyzes the 2D image captured by the camera 104 based on fiducial markers 136 depicted in the 2D image. In various implementations, the fiducial markers 136 include stickers and/or labels disposed at various positions around the room 102. In some cases, the fiducial markers 136 include barcodes, such as Quick Response (QR) codes and/or ArUco codes. QR codes and ArUco codes are examples of two-dimensional barcodes. ArUco codes are described, for instance, in S. Garrido-Jurado, et al., PATTERN RECOGN. 47, 6 (June 2014), 2280-92, which is incorporated by reference herein in its entirety. In general, ArUco codes are generated in accordance with a predetermined dictionary of shapes. Based on the dictionary and an image of an example ArUco code, the position (e.g., orientation and distance with respect to the camera capturing the image) can be derived. The fiducial markers 136 may be disposed on positions of the support structure 112, such as on railings of the support structure 112, on corners of the support structure 112, on sides of the support structure 112, or the like. The fiducial markers 136 may be disposed on the display device 118, such as on a border of the screen 120. In some cases, the screen 120 itself displays one or more of the fiducial markers 136. Although the fiducial markers 136 are primarily described as barcodes in the present disclosure, implementations are not so limited. In various implementations, the fiducial markers 136 can be represented by any type of optical signal that is detected by the camera 104.

The imaging system 134 may identify the fiducial markers 136 in the 2D image captured by the camera 104. Based on the fiducial markers 136, the imaging system 134 may determine a distance between the camera 104 and the fiducial markers 136, as well as an orientation of the fiducial markers 136. In various implementations, the location of the fiducial markers 136 (e.g., on the support structure 112 and/or the display device 118) are known by the imaging system 134 in advance, such as in a look-up table stored by the imaging system 134. Accordingly, the imaging system 134 may be able to identify the location and/or orientation of other subjects in the room 102 based on their apparent proximity to the fiducial markers 136 depicted in the 2D image.

In particular cases, the imaging system 134 may further analyze images captured by the camera 104 based on other sources of data. For example, the imaging system 134 may receive data indicative of weights detected by the load cells 114 in the support structure 112 from the support structure 112. In various implementations, the imaging system 134 may confirm a position and/or orientation of the patient 110 on the support structure 112 based on the data from the support structure 112.

The imaging system 134 may perform various actions based on the 3D image (e.g., generated using the first optical instrument 124 and/or the second optical instrument 126), the location of a subject in the room 102, the orientation of the subject in the room 102, or a combination thereof. In some implementations, the imaging system 134 identifies a pose of the patient 110. As used herein, the term “pose,” and its equivalents, refers to a relative orientation of limbs, a trunk, a head, and other applicable components of a frame representing an individual. For example, the pose of the patient 110 depends on the relative angle and/or position of the arms and legs of the patient 110 to the trunk of the patient 110, as well as the angle of the arms and legs of the patient 110 to the direction of gravity within the clinical setting. In particular implementations, the imaging system 134 estimates a frame associated with a recognized object in the images, wherein the object depicts an individual. The frame, in some cases, overlaps with at least a portion of the skeleton of the individual. The frame includes one or more beams and one or more joints. Each beam is represented by a line that extends from at least one joint. In some cases, each beam is represented as a line segment with a fixed length. In some implementations, each beam is presumed to be rigid (i.e., non-bending), but implementations are not so limited. In an example frame, beams may represent a spine, a trunk, a head, a neck, a clavicle, a scapula, a humerus, a radius and/or ulna, a femur, a tibia and/or fibula, a hip, a foot, or any combination thereof. Each joint may be represented as a point and/or a sphere. For example, an individual joint is modeled as a hinge, a ball and socket, or a pivot joint. In an example frame, joints may represent a knee, a hip, an ankle, an elbow, a shoulder, a vertebra, a wrist, or the like. In various implementations, the frame includes one or more keypoints. Keypoints include joints as well as other components of the frame that are not connected to any beams, such as eyes, ears, a nose, a chin, or other points of reference of the individual. The imaging system 134 can use any suitable pose estimation technique, such as PoseNet from TensorFlow. In various implementations, the imaging system 134 identifies the pose of the patient 110, the care provider 116, or any other individual depicted in the images captured by the camera 104.

In some implementations, the imaging system 134 generates and transmits a control signal to the robot 122 based on the 3D image. For example, the control signal may cause the robot 122 to move around the room 102 in such a way that causes the robot 122 to avoid running into subjects within the room 102. In some implementations, the control signal may cause the robot 122 to encounter a subject in the room and perform an action on the subject.

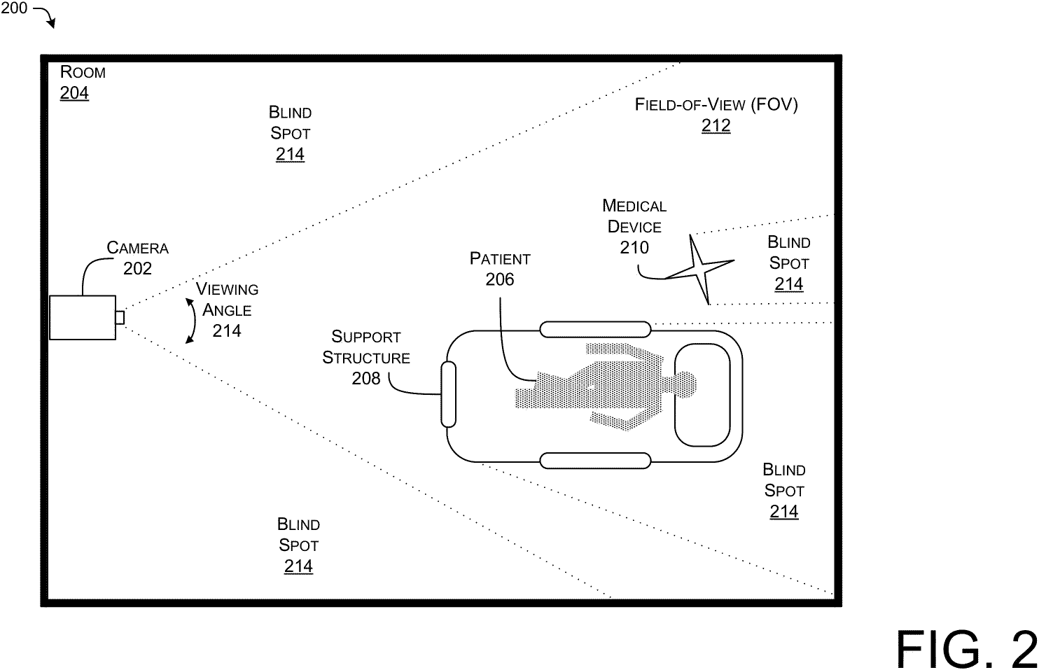

FIG. 2 illustrates an environment 200 including a camera 202 monitoring a room 204, wherein the camera 202 has a limited FOV. In some cases, the camera 202 is the camera 104 described above with reference to FIG. 1. The room 204 may be the room 102 described above with reference to FIG. 1.

A patient 206 may be present inside of the room 204. For example, the patient 206 may be resting on a support structure 208. Furthermore, a medical device 210 may be located within the room 204. For example, the medical device 210 includes an IV drip apparatus or vital sign monitor configured to detect a vital sign of the patient 206. The patient 206, the support structure 208, and the medical device 210 may be opaque subjects within the room 204.

The camera 202 may be associated with an FOV 212, which represents a volume of the room 204 from which the camera 202 receives light. An image detected by the camera 202 may depict subjects limited to the FOV 212 of the camera 202. In various examples, edges of the FOV 212 are defined according to a viewing angle 214, which may be dependent on lenses within the camera 202 and/or photosensors within the camera 202. In addition, the FOV 212 of the camera 204 is limited based on opaque subjects within the room 204. For example, the camera 202 may be unable to receive light transmitted from behind the patient 206, the support structure 208, and the medical device 210 due to the opacity of the patient 206, the support structure 208, and the medical device 210.

Due to the limited FOV 212 of the camera 202, there are multiple blind spots 214 within the room 204. The blind spots 214 include volumes of the room 204 from which the camera 202 does not receive light. Accordingly, images captured by the camera 202 do not depict subjects within the blind spots 214. The blind spots 214 can be problematic for various reasons. For example, if the images captured by the camera 202 are used to track subjects within the room 204 (e.g., to track unauthorized items, such as illicit drugs or food when the patient 206 is NPO), those subjects cannot be effectively tracked if they are located in the blind spots 214. In some examples, a condition of the patient 206 (e.g., a propensity for developing pressure injuries or other adverse events) is assessed based on the images obtained from the camera 202, but the blind spots 214 may prevent the images from capturing important events that are relevant to assessing the condition of the patient 206 (e.g., the patient 206 sliding down in the support structure 208).

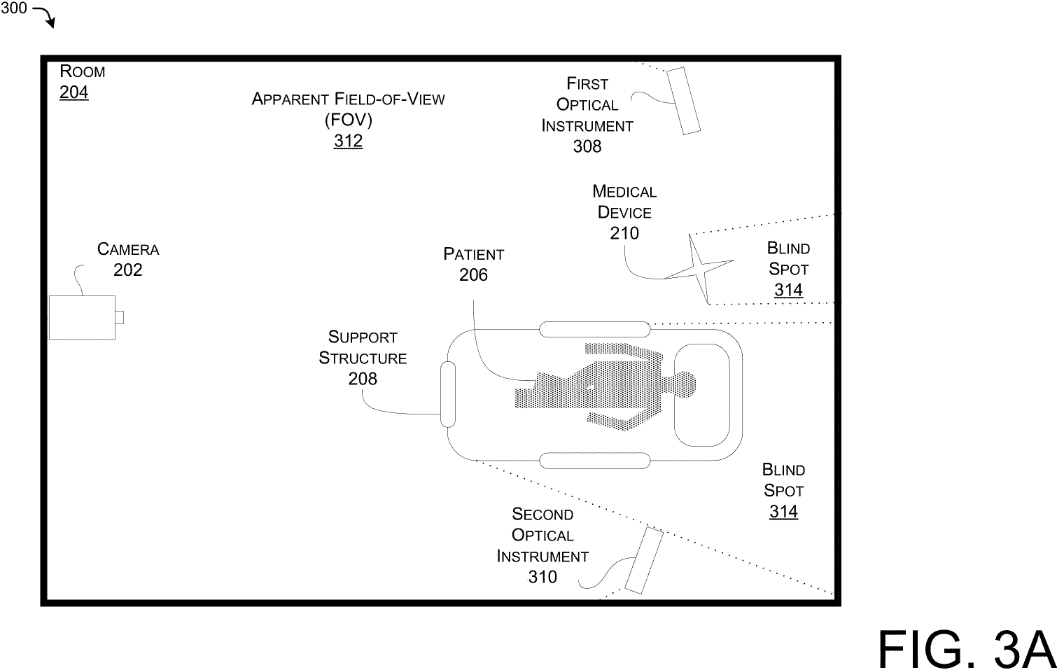

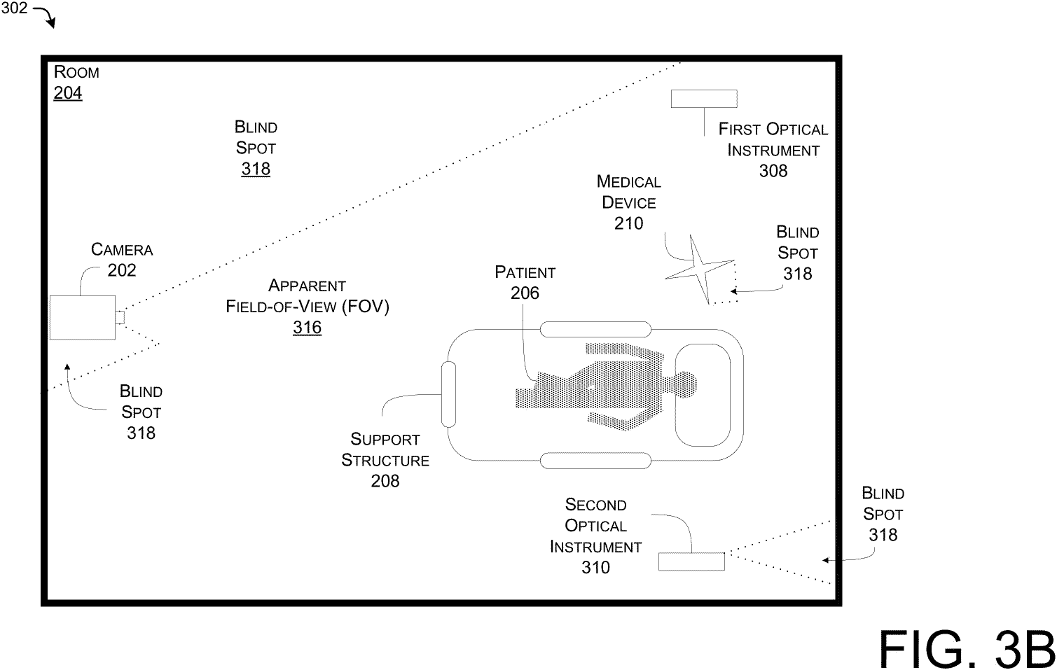

FIGS. 3A and 3B illustrate examples of environments 300 and 302 including optical instruments 304 and 306 configured to increase the apparent FOV of the camera 202. The environments 300 and 302 include the camera 202, the room 204, the patient 206, the support structure 208, and the medical device 210 described above with reference to FIG. 2.

As shown in FIG. 3A, the environment 300 includes a first optical instrument 308 and a second optical instrument 310 disposed inside of the room 204. In various implementations, the first optical instrument 308 and the second optical instrument 310 are configured to alter the path of light. For example, the first optical instrument 308 and the second optical instrument 310 include one or more mirrors configured to reflect light, one or more lenses configured to refract light, or a combination thereof. Based on altered path of the light, the first optical instrument 308 and the second optical instrument 310 respectively generate virtual images of the room 204. Images captured by the camera 202 include the virtual images, for example.

In various implementations, the first optical instrument 308 and the second optical instrument 310 expand an apparent FOV 312 of the camera 202 in the environment 300. For example, the first optical instrument 308 and the second optical instrument 310 generate virtual images depicting regions of the camera 202 beyond a boundary of a viewing angle (e.g., the viewing angle 214) of the camera 202 itself, thereby eliminating at least some of the blind spots of the camera 202. Although the apparent FOV 312 of the camera 202 in the environment 300 is larger than the apparent FOV 312 of the camera 202 in the environment 200, there are still blind spots 314 of the camera 202 in the environment 200. In particular, these blind spots 314 reside behind the patient 206, the support structure 208, and the medical device 210. However, the blind spots 314 are fewer in number and/or smaller than the blind spots 214.

As shown in FIG. 3B, the environment 302 also includes the first optical instrument 308 and the second optical instrument 310 disposed inside of the room 204. However, the first optical instrument 308 and the second optical instrument 310 are disposed at different orientations in the environment 302 than in the environment 300. Accordingly, the virtual images generated by first optical instrument 308 and the second optical instrument 310 in the environment 302 may be different than the virtual images generated by the first optical instrument 308 and the second optical instrument 310 in the environment 300. Accordingly, an apparent FOV 316 of the camera 202 in the environment 302 is different than the apparent FOV 312 of the camera 202 in the environment 300. Blind spots 318 of the camera 202 in the environment 302 may be different than the blind spots 314 in the environment 300.

The images captured by the camera 200 in the environment 300 and the environment 302 may be combined in order to obtain the apparent FOV 312 of the camera 202. For example, the images are first segmented into multiple disjoint subsets using information known about the optical instruments 308 and 310, such as the position and/or orientation of the optical instruments 308 and 310 and camera 200, calibration angles of the optical instruments 308 and 310 and camera 200, projection angles of the optical instruments 308 and 210 and camera 200, or any combination thereof. These image sets can be assumed as projections of the 3D space into a 2D space. The projections can be combined using an adaptive inverse radon transform, filtered back projection, iterative reconstruction, or some other tomographic reconstruction technique, to generate a 3D representation of the environment 302. Collectively, the images captured by the camera 202 in the environment 300 and the environment 302 provide a combined FOV that is greater than the FOV 212, the apparent FOV 312, or the apparent FOV 314, individually. Accordingly, a more holistic view of the room 204 can be obtained with the camera 202 by capturing images when the first optical instrument 308 and the second optical instrument 310 are positioned at different orientations. In some cases, the repositioning of the first optical instrument 308 and the second optical instrument 310 is performed automatically by an imaging system that controls the camera 202. In various implementations, the first optical instrument 308 and the second optical instrument 310 can provide visibility into a significant volume of the room 204 using a single 2D camera (e.g., the camera 202).

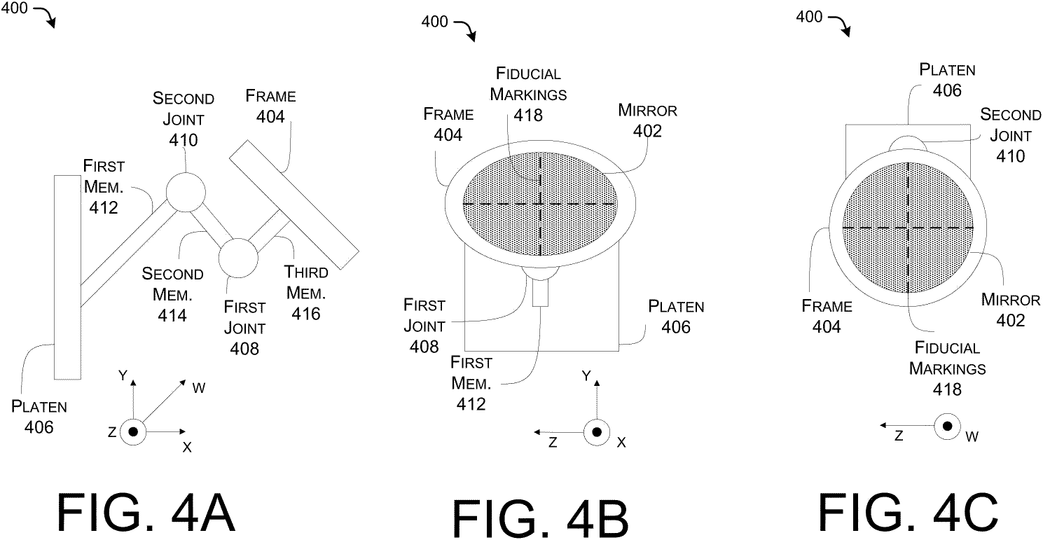

FIGS. 4A to 4C illustrate views of an example optical instrument 400. In particular, FIG. 4A illustrates the optical instrument 400 in a reverse z direction along a plane defined according to w, x, and y directions; FIG. 4B illustrates the optical instrument 400 in a reverse x direction along a plane defined according to the y and z directions; and FIG. 4C illustrates the optical instrument 400 in a reverse w direction along a plane parallel to the z direction.

The optical instrument 400 includes a mirror 402 disposed in a frame 404. The mirror 402 is configured to reflect light. The mirror 402, for example, includes a reflective metal film (e.g., aluminum, silver, etc.) disposed on a transparent coating (e.g., glass, borosilicate, acrylic, etc.), wherein the transparent coating faces the w direction. In various implementations, a surface of the mirror 402 is flat, but implementations are not so limited. For example, in some cases, the surface of the mirror 402 is curved or has a corner. In some cases, the surface of the mirror 402 can be stretched, bent, twisted, or otherwise manipulated by a mechanical device. The frame 404 is disposed around an edge of the mirror 402, in various cases, and connects the mirror 402 to other components of the optical instrument 400. In some implementations, the frame 404 includes a metal and/or a polymer.

The mirror 402 and the frame 404 are connected to a platen 406 via a first joint 408 and a second joint 410 that connect a first member 412, a second member 414, and a third member 416. The platen 406 may include a metal and/or a polymer. In various implementations, the platen 406 is attached to a mounting surface, such as a wall, a corner, a sign, or a post. The platen 406 may be attached to the mounting surface via an adhesive, nails, screws, or other types of fasteners. The first joint 408 connects the second member 414 to the third member 416; the second j oint 410 connects the first member 412 to the second member 414. In various implementations, the first joint 408 and the second joint 410 include one or more ball-and-socket joints, one or more pin joints, one or more knuckle joints, etc. Each one of the first joint 408 and the second joint 410 may provide one or more degrees of freedom to their respectively attached members.

In some examples, the first j oint 408 and/or the second j oint 410 are coupled to one or more mechanical actuators configured to change an orientation and/or angle of the first joint 408 and/or the second joint 410. For example, the first joint 408, the second joint 410, the first member 412, the second member 414, the third member 416, or any combination thereof can comprise an articulated robotic arm, wherein the position and orientation of the mirror 402 in 3D space is controlled by the mechanical actuator(s). In some cases, the mechanical actuator(s) operate based on control signals received from an external imaging system.

Fiducial markings 418 are disposed on the mirror 402. In some implementations, the fiducial markings 418 include a pattern printed on an outer surface of the mirror 412. The fiducial markings 418, for example, are printed in an IR ink that is discernible to photosensors configured to detect IR light (e.g., photosensors in an IR camera). The fiducial markings 418 may be invisible to the human eye, in some cases.

In various implementations, a pattern of the fiducial markings 418 are predetermined by an imaging system that identifies an image of the optical instrument 400. For example, the imaging system may include a camera configured to obtain the image or may receive the image from the camera. In some cases, the pattern of the fiducial markings 418 are prestored in memory of the imaging system. For instance, the fiducial markings 418 illustrated in FIG. 4 include various dashes with equivalent lengths, and the imaging system may store the length of the dashes. In various implementations, the imaging system may identify the orientation of the mirror 402 relative to the camera by comparing the predetermined pattern of the fiducial markings 418 with the apparent pattern of the fiducial markings 418 depicted in the image of the optical instrument 400. For example, the imaging system may determine that the orientation of the mirror 402 is angled with respect to a sensing face of the camera by determining that the fiducial markings 418 depicted in the image have inconsistent lengths. In some cases, the imaging system may infer the distance between the camera and the mirror 402 (and/or the distance between the mirror 402 and subjects reflected in the mirror 402) based on the relative lengths of the fiducial markings 418 depicted in the image and the known lengths of the fiducial markings 418. In some cases, the fiducial markings 418 include one or more ArUco codes, and the imaging system is configured to identify the distance and/or orientation of the mirror 402 based on the ArUco code(s) depicted in the image.

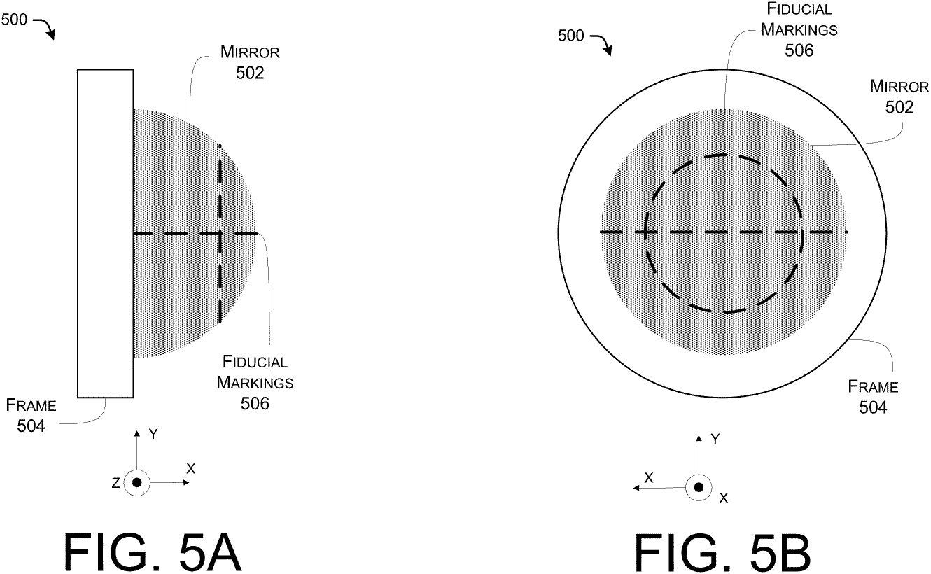

FIGS. 5A and 5B illustrate examples of an optical instrument 500 with a curved reflective surface. The optical instrument 500 is illustrated from a reverse z direction in FIG. 5A along a plane that is defined in x and y directions; and illustrated from a reverse x direction in FIG. 5B along a plane that is defined in the z and y directions.

The optical instrument 500 includes a mirror 502 disposed in a frame 504. The mirror 502 is configured to reflect light. The mirror 502, for example, includes a reflective metal film (e.g., aluminum, silver, etc.) disposed on a transparent coating (e.g., glass, borosilicate, acrylic, etc.), wherein the transparent coating faces the w direction. In various implementations, a surface of the mirror 502 is curved (e.g., hemispherical). The curved surface of the mirror 502 enables it to reflect a wider environment than if the mirror 502 were flat.

In some cases, the surface of the mirror 502 can be stretched, bent, twisted, or otherwise manipulated by a mechanical device. The frame 504 is disposed around an edge of the mirror 502. In some implementations, the frame 504 includes a metal and/or a polymer. Although not specifically illustrated in FIGS. 5A and 5B, in some examples, the frame 504 is attached to an articulating arm that can be used to adjust the position and/or orientation of the mirror 502 in 3D space. In various implementations, the frame 504 is attached to a mounting surface directly or the articulating arm is attached to the mounting surface.

Fiducial markings 506 are disposed on the mirror 502. In some implementations, the fiducial markings 506 include a pattern printed on an outer surface of the mirror 502. The fiducial markings 506, for example, are printed in an IR ink that is discernible to photosensors configured to detect IR light (e.g., photosensors in an IR camera). The fiducial markings 506 may be invisible to the human eye, in some cases.

In various implementations, a pattern of the fiducial markings 506 are predetermined by an imaging system that identifies an image of the optical instrument 500. For example, the imaging system may include a camera configured to obtain the image or may receive the image from the camera. In some cases, the pattern of the fiducial markings 506 are prestored in memory of the imaging system. For instance, the fiducial markings 506 illustrated in FIGS. 5A and 5B include various dashes with equivalent lengths, and the imaging system may store the length of the dashes. The imaging system may store a dimension of the circular shape of the fiducial markings 506. In various implementations, the imaging system may identify the orientation of the mirror 502 relative to the camera by comparing the predetermined pattern of the fiducial markings 506 with the apparent pattern of the fiducial markings 506 depicted in the image of the optical instrument 500. For example, the imaging system may determine that the orientation of the mirror 502 is angled with respect to a sensing face of the camera based on comparing the fiducial markings 506 depicted in the image to the stored fiducial markings 506 lengths. In some cases, the imaging system may infer the distance between the camera and the mirror 502 (and/or the distance between the mirror 502 and subjects reflected in the mirror 502) based on the relative lengths of the fiducial markings 506 depicted in the image and the known lengths of the fiducial markings 506. In some cases, the fiducial markings 506 include one or more ArUco codes, and the imaging system is configured to identify the distance and/or orientation of the mirror 502 based on the ArUco code(s) depicted in the image.

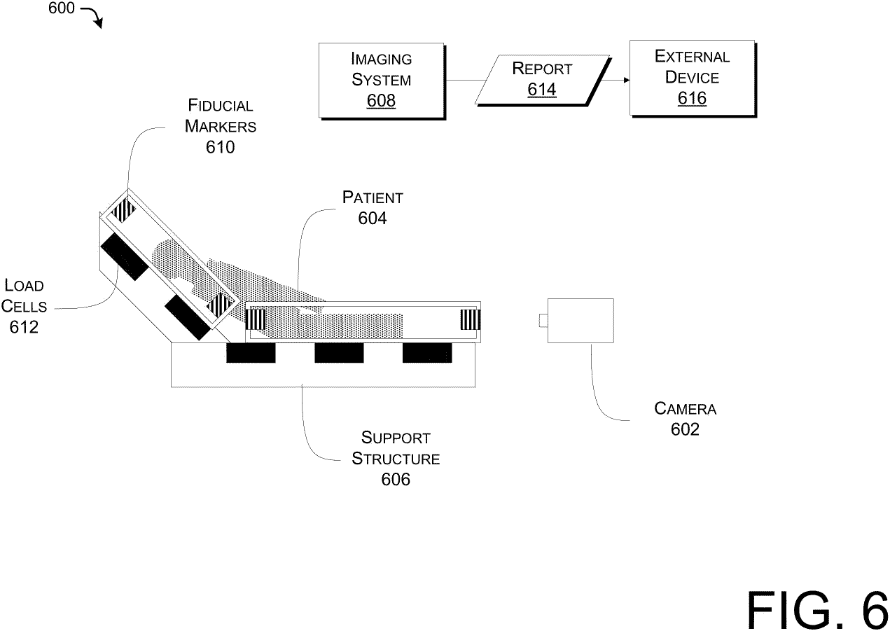

FIG. 6 illustrates an example environment 600 for estimating depth information using 2D imaging. The environment 600 includes a camera 602 configured to capture 2D images of a 3D space. The camera 602, for example, may be the camera 104 described above with reference to FIG. 1. A patient 604 is disposed in the 3D space. The patient 604, for example, is the patient 110 described above with reference to FIG. 1. Further, the patient 604 is disposed on a support structure 606 in the 3D space. In some cases, the support structure 606 is the support structure 112 described above with reference to FIG. 1. In various implementations, the camera 602 may capture a 2D image of the 3D space, wherein the image depicts the patient 604 and the support structure 606. The camera 602 may transmit the image to an imaging system 608 for further processing. In some examples, the imaging system 608 is the imaging system 134 described above with reference to FIG. 1.

In various implementations, the imaging system 608 is configured to track or otherwise analyze the patient 604 based on the image captured by the camera 602. In various implementations, the imaging system 608 tracks one or more objects in the images captured by the camera 602, including the patient 604. For example, the imaging system 608 detects an object in one of the images. In some implementations, the imaging system 608 detects the object using edge detection. The imaging system 608, for example, detects one or more discontinuities in brightness within the image. The one or more discontinuities may correspond to one or more edges of a discrete object in the image. To detect the edge(s) of the object, the imaging system 608 may utilize one or more edge detection techniques, such as the Sobel method, the Canny method, the Prewitt method, the Roberts method, or a fuzzy logic method.

According to some examples, the imaging system 608 identifies the detected object. For example, the imaging system 608 performs image-based object recognition on the detected object. In some examples, the risk imaging system 608 uses a non-neural approach to identify the detected object, such as the Viola-Jones object detection framework (e.g., based on Haar features), a scale-invariant feature transform (SIFT), or a histogram of oriented gradients (HOG) features. In various implementations, the imaging system 608 uses a neural-network-based approach to identify the detected object, such as using a region proposal technique (e.g., R convolutional neural network (R-CNN) or fast R-CNN), a single shot multibox detector (SSD), a you only look once (YOLO) technique, a single-shot refinement neural network (RefineDet) technique, a retina-net, or a deformable convolutional network. In various examples, the imaging system 608 determines that the detected object is the patient 604.

In various implementations, the imaging system 608 tracks the object throughout the multiple images captured by the camera 602. The imaging system 608 may associate the object depicted in consecutive images captured by the camera 602. In various cases, the object is representative of a 3D subject within the clinical setting, which can be translated within the clinical setting in 3 dimensions (e.g., an x-dimension, a y-dimension, and a z-dimension). The imaging system 608 may infer that the subject has moved closer to, or farther away, from the camera 602 by determining that the object representing the subject has changed size in consecutive images. In various implementations, the imaging system 608 may infer that the subject has moved in a direction that is parallel to a sensing face of the camera 602 by determining that the object representing the subject has changed position along the width or height dimensions of the images captured by the camera 602.

Further, because the subject is a 3D subject, the imaging system 608 may also determine if the subject has changed shape and/or orientation with respect to the camera 602. For example, the imaging system 608 may determine if the patient 604 has bent down and/or turned around within the clinical setting. In various implementations, the imaging system 608 utilizes affine transformation and/or homography to track the object throughout multiple images captured by the camera 602.

According to some instances, the imaging system 608 identifies the position and/or movement of various subjects depicted in the images captured by the camera 602 by tracking the objects representing those subjects. In various cases, the imaging system 608 determines a relative position (e.g., distance) and/or movement of multiple subjects depicted in the images. For example, the imaging system 608 is configured to determine whether the patient 604 is touching, moving toward, or moving away, from the support structure 606 using the image tracking techniques described herein. For example, the imaging system 608 may track the patient 602 throughout multiple images captured by the camera 602.

In some implementations, the imaging system 608 is configured to identify a pose of the patient 604 based on the image. As used herein, the term “pose,” and its equivalents, refers to a relative orientation of limbs, a trunk, a head, and other applicable components of a frame representing an individual. For example, the pose of the patient 604 depends on the relative angle and/or position of the arms and legs of the patient 604 to the trunk of the patient 604, as well as the angle of the arms and legs of the patient 604 to the direction of gravity within the clinical setting. In some implementations, the pose of the patient 604 is indicative of whether at least one foot of the patient 604 is angled toward the foot of the support structure 606. For example, the pose of the patient 604 may indicate “foot drop” of the patient 604. In particular implementations, the imaging system 608 estimates a frame associated with a recognized object in the images, wherein the object depicts an individual. The frame, in some cases, overlaps with at least a portion of the skeleton of the individual. The frame includes one or more beams and one or more joints. Each beam is represented by a line that extends from at least one joint. In some cases, each beam is represented as a line segment with a fixed length. In some implementations, each beam is presumed to be rigid (i.e., non-bending), but implementations are not so limited. In an example frame, beams may represent a spine, a trunk, a head, a neck, a clavicle, a scapula, a humerus, a radius and/or ulna, a femur, a tibia and/or fibula, a hip, a foot, or any combination thereof. Each j oint may be represented as a point and/or a sphere. For example, an individual joint is modeled as a hinge, a ball and socket, or a pivot joint. In an example frame, joints may represent a knee, a hip, an ankle, an elbow, a shoulder, a vertebra, a wrist, or the like. In various implementations, the frame includes one or more points (also referred to as “keypoints”). Points include joints as well as other components of the frame that are not connected to any beams, such as eyes, ears, a nose, a chin, or other points of reference of the individual. The imaging system 608 can use any suitable pose estimation technique, such as PoseNet from TensorFlow.

The imaging system 608 may perform any of the image analysis techniques described herein using a computing model, such as a machine learning (ML) model. As used herein, the terms “machine learning,” “ML,” and their equivalents, may refer to a computing model that can be optimized to accurately recreate certain outputs based on certain inputs. In some examples, the ML models include deep learning models, such as convolutional neural networks (CNN). The term Neural Network (NN), and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A NN may further include at least one fully connected layer that receives a feature map output by the hidden layers and transforms the feature map into the output of the NN.

As used herein, the term “CNN,” and its equivalents and variants, may refer to a type of NN model that performs at least one convolution (or cross correlation) operation on an input image and may generate an output image based on the convolved (or cross-correlated) input image. A CNN may include multiple layers that transform an input image (e.g., an image of the clinical setting) into an output image via a convolutional or cross-correlative model defined according to one or more parameters. The parameters of a given layer may correspond to one or more filters, which may be digital image filters that can be represented as images (e.g., 2D images). A filter in a layer may correspond to a neuron in the layer. A layer in the CNN may convolve or cross-correlate its corresponding filter(s) with the input image in order to generate the output image. In various examples, a neuron in a layer of the CNN may be connected to a subset of neurons in a previous layer of the CNN, such that the neuron may receive an input from the subset of neurons in the previous layer, and may output at least a portion of an output image by performing an operation (e.g., a dot product, convolution, cross-correlation, or the like) on the input from the subset of neurons in the previous layer. The subset of neurons in the previous layer may be defined according to a “receptive field” of the neuron, which may also correspond to the filter size of the neuron. U-Net (see, e.g., Ronneberger, et al., arXiv: 1505.04597v1, 2015) is an example of a CNN model.

The imaging system 608, for example, may include an ML model that is pre-trained based on training images that depict the features, as well as indications that the training images depict the features. For example, one or more expert graders may review the training images and indicate whether they identify the features in the training images. Data indicative of the training images, as well as the gradings by the expert grader(s), may be used to train the ML models. The ML models may be therefore trained to identify the features in the images obtained by the camera 602. The features may be associated with identifying objects (e.g., recognizing the shape of the support structure 606 in the images), identifying movements (e.g., recognizing seizures or violent movements by individuals depicted in the images), identifying the pose of an individual depicted in the images, or identifying other visual characteristics associated with risks to individuals in the clinical setting.

In some implementations, the imaging system 608 is configured to identify an event based on the image, such as to determine whether the patient 604 has exited a bed, chair, or fallen down based on the image. In some examples, the imaging system 608 identifies a risk that the patient 604 has and/or will experience a fall. In various implementations, the risk increases based on an elevation of the patient 604 with respect to the support structure 606 and/or the floor. For example, the patient 604 has a relatively low falls risk if the patient 604 is resting on the support structure 606 or sitting upright on the floor, but a relatively higher falls risk if the patient 604 is laying down on the floor. In some cases, the imaging system 608 determines the falls risk based on a movement of the patient 604. For example, the imaging system 608 may determine that the patient 604 has a heightened falls risk if the patient 604 is moving stochastically (e.g., shaking) or in an unbalanced fashion while the pose of the patient 604 is upright. In some cases, the imaging system 608 determines that the patient 604 is at a heightened risk of a fall by determining that the patient 604 has exited the support structure 606 or a chair.

In various cases, the falls risk of the patient 604 can be determined based on whether the patient 604 has paused during a sit-to-walk maneuver. In some examples, the pause may indicate that the height of the support structure 606 is too low. Other transitions of movements can also be indicative of the condition of the patient 604. For instance, a transition by the patient 604 from standing to walking without a pause may indicate that the patient 604 has good balance and/or a low falls risk. According to some implementations, the imaging system 608 detects a pause in a movement of the patient 604. Based on the pause (e.g., determining that the duration of the pause is greater than a threshold time), the imaging system 608 may output an alert or notification, such as an alert to a clinical device instructing a care provider to increase the height of the support structure 606 and/or a signal to the support structure 606 itself that causes the support structure 606 to automatically adjust its height.

According to some cases, the imaging system 608 is configured to determine whether the patient 604 has a dangerous posture on the support structure 606 based on the image. For example, the imaging system 608 is configured to identify whether the patient 604 has slid down the support structure 606 and/or a neck of the patient 604 is at greater than a threshold angle associated with an increased risk of aspirating. In some cases, the imaging system 608 identifies a risk that the patient 604 has and/or will aspirate. In various implementations, the imaging system 608 identifies the risk based on a pose of the patient 604. The risk of aspiration increases, for instance, if the angle of the neck of the patient 604 is within a particular range and/or the head of the patient 604 is lower than a particular elevation with respect to the rest of the patient’s 604 body. In some examples, the support structure 606 is configured to elevate the head of the patient 604 but the risk of aspiration increases if the patient’s 604 body slides down the support structure 606 over time. For example, the imaging system 608 determines the risk that the patient 604 will aspirate based on the angle of the patient’s 604 neck, the elevation of the patient’s 604 head with respect to the elevation of the patient’s 604 trunk or torso, and whether the patient 604 has slid down the support structure 606. In some examples, the imaging system 608 is configured to detect entrapment of the patient 604, such as a neck of the patient 604 being caught between a bed and side-rail of the support structure 606.

In various implementations, the imaging system 608 is configured to identify other types of conditions of the patient 604. For example, the imaging system 608 may analyze an image captured by the camera 602 to determine whether the patient 604 is experiencing a seizure, is consuming food or drink, is awake, is asleep, is absconding, is in pain, or the like.

Because the camera 602 is configured to capture a 2D image from a single perspective, the imaging system 608 may be unable to accurately identify the condition of the patient 604 based on the image captured by the camera 602, alone. For example, in the example illustrated in FIG. 6, a direction that the camera 602 faces the patient 604 is parallel to the legs of the patient 604. Accordingly, based on the 2D image from the camera 602, the imaging system 608 may be unable to discern whether the legs of the patient 604 are extended, the patient 604 has short legs, or the patient 604 has missing legs. Without further information about 3D position of the patient 604 in the 3D space, the imaging system 608 may be unable to accurately estimate the pose of the patient 604 or accurately identify the condition of the patient 604.

In various implementations, the imaging system 608 infers 3D depth information of the 3D space based on the 2D image captured by the camera 602. For instance, the imaging system 608 may determine a distance between the camera 602 and at least one portion of the patient 604 and/or at least one portion of the support structure 112. The imaging system 608 may determine the pose of the patient 604 or otherwise analyze the position of the patient 604 based on the distance.

The camera 602 may capture multiple images of the 3D space at different focal lengths. As used herein, the term “focal length” and its equivalents refers to a distance between a lens and a photosensor. For example, the camera 602 may generate multiple images of the 3D space with focal lengths that are separated by a particular interval, 100 millimeters (mm), 10 mm, 1 mm, or some other distance. The camera 602 may adjust the focal length by adjusting a position of one or more lenses included in the camera 602. In general, the focal length of the camera 602 corresponds to the distance between the camera and subjects that are in-focus in images captured by the camera. For example, a distance between the camera 602 and a focus plane within the 3D space is correlated to the focal length of the camera 602. When a subject is in the focal plane, light transmitted from the subject is focused onto the photosensor of the camera 602, and therefore appears in-focus in the image captured by the camera 602 at that focal length.

For a given image captured by the camera 602, the imaging system 608 may infer the distance between the camera 602 and a subject within the 3D space by determining whether the depiction of the subject in the image is in in-focus or out-of-focus. According to some implementations, the camera 602 may identify a subject, such as a head of the patient 604, in each of multiple images captured by the camera 602 at multiple focal lengths. The imaging system 608 may calculate a sharpness of the depicted head of the patient 604 in each of the images. The image wherein the depicted head of the patient 604 has a greater than threshold sharpness (or the greatest sharpness) may be the image where the depicted head of the patient 604 is in-focus. The imaging system 608 may identify the focal length of the camera 602 used to capture the identified image. Based on the lens optics of the camera 602 and the focal length, the imaging system 608 may estimate the distance between the camera 602 and the head of the patient 604. In various implementations, the imaging system 608 may repeat a similar process to determine the distance between other subjects in the 3D space and the camera 602, such as a foot of the patient 604, a knee of the patient 604, a hand of the patient 604, an elbow of the patient 604, a torso of the patient 604, or the like. Based on the distance between subjects in the 3D space and the camera 602, the imaging system 608 may more accurately identify a pose and/or condition of the patient 604. For example, the imaging system 608 may be able to recognize that the legs of the patient 604 are extended towards the camera 602, rather than short.

In some cases, the camera 602 generates an image depicting one or more fiducial markers 610 disposed in the 3D space. The fiducial markers 610, for example, are disposed at predetermined locations on the support structure 606. In some cases, the fiducial markers 610 are disposed on a bed of the support structure 606, on a rail (e.g., a hand, foot, or head rail) of the support structure 606, or some other part of the support structure 606. In some cases, the fiducial markers 610 include at least one QR code and/or at least one ArUco code. The fiducial markers 610 may identify the support structure 606. For instance, the QR code and/or ArUco code may encode an identifier (e.g., a string, a number, or some other type of value) that is uniquely associated with the support structure 606 and/or the patient 604. Accordingly, the imaging system 608 may specifically identify the support structure 606 based on the fiducial markers 610. In some cases, a clinical setting including the support structure 606 may include multiple support structures, wherein each of the multiple support structures has a unique identifier.

The imaging system 608 may be able to identify the position and/or orientation of the support structure 606 based on the fiducial markers 610 depicted in the image captured by the camera 602. The imaging system 608 may identify the locations of the fiducial markers 610 on the support structure 606. According to some implementations, the imaging system 608 may identify that a particular fiducial marker 610 depicted in the image is disposed on a rail of the support structure 606. For example, the imaging system 608 may store an indication that the fiducial marker 610 is disposed on the rail in local memory and/or the fiducial marker 610 itself may encode the indication.

The imaging system 608 may determine a distance between each fiducial marker 610 and the camera 602 based on the image. For example, the fiducial markers 610 have a relatively small size in the image if they are located relatively far from the camera 602, and may have a relatively large size in the image if they are located relatively close to the camera 602. In some examples, the fiducial markers 610 have a consistent size, so that any relative discrepancies between the depictions of the fiducial markers 610 in the image can be used to infer distances between the fiducial markers 610 in the image.

In some cases, the imaging system 608 may determine an orientation of each fiducial marker 610 with respect to the camera 602 based on the image. For example, the fiducial markers 610 may have a predetermined shape (e.g., a square, a circle, or the like). The imaging system 608 may identify distortions of the depicted fiducial markers 610 with respect to the predetermined shape, and may determine whether the fiducial markers 610 are rotated and/or angled with respect the camera 602 based on the distortions. In some cases, the imaging system 608 may analyze ArUco codes in the fiducial markers 610 directly to identify their location within the 3D space.

In various implementations, the imaging system 608 may further identify the dimensions of the support structure 606 itself. For example, the dimensions may be prestored in the imaging system 608. By comparing the known relative locations of the fiducial markers 610 on the support structure 606, the locations of the fiducial markers 610 in the 3D space, and the known dimensions of the support structure, the imaging system 608 may determine the location and/or orientation of the support structure 606 within the 3D space. In various implementations, the imaging system 608 may use the location and/or orientation of the support structure as context for determining the location and/or orientation of the patient 604 within the 3D space. Accordingly, the imaging system 608 may determine the pose and/or condition of the patient 604 based on the fiducial markers 610. For example, the imaging system 608 may determine that the patient 604 has slid down in the support structure 606 by comparing the determined location of the patient 604 to the determined location of the support structure 606.

In some implementations, the imaging system 608 may use bed data to confirm the pose, location, or condition of the patient 604. For example, the support structure 606 includes multiple load cells 612 configured to detect a pressure and/or weight on distinct regions of the support structure 606. The support structure 606 and/or the load cells 612 may include transmitters configured to transmit data indicative of the pressures and/or weights to the imaging system 608. In various implementations, the imaging system 608 may determine the pose and/or condition of the patient 604 based on the pressures and/or weights. For instance, the imaging system 608 may confirm points of contact between the patient 604 and the support structure 606 based on the pressures and/or weights detected by the load cells 612. In particular examples, the imaging system 608 may confirm that the legs of the patient 604 are extended on the support structure 606 based on pressures and/or weights detected by the load cells 612 at the foot of the support structure 606.

According to some implementations, the imaging system 608 may include a sensor configured to detect an angle between a head portion of the support structure 606 and a foot portion of the support structure 606. The sensor and/or the support structure 606 may transmit data indicative of the angle to the imaging system 608. The imaging system 608 may determine the pose and/or condition of the patient 604 based on the angle of the support structure 606. For example, the imaging system 608 may determine that the patient 604 is resting on the support structure 606 (e.g., based on the pressures and/or weights detected by the load cells 612), and may determine the pose of the patient 604 based on the angle at which the angle of the support structure 606.

In various implementations, the imaging system 608 may generate a report 614 based on the pose and/or condition of the patient 604. For example, the report 614 may indicate the pose of the patient 604, that patient 604 has fallen down, that the patient 604 has a risky posture (e.g., an angle of the neck of the patient is greater than a threshold angle associated with a risk of aspiration), the patient 604 has slid down in the support structure 606, or the like. The imaging system 608 may transmit the report 614 to an external device 616. The external device 616 may be a computing device. In some cases, the external device 616 outputs the report 614 to a user. For instance, the external device 616 may be a tablet computer associated with a clinical provider, and the external device 616 may output the report 614 to the clinical provider.

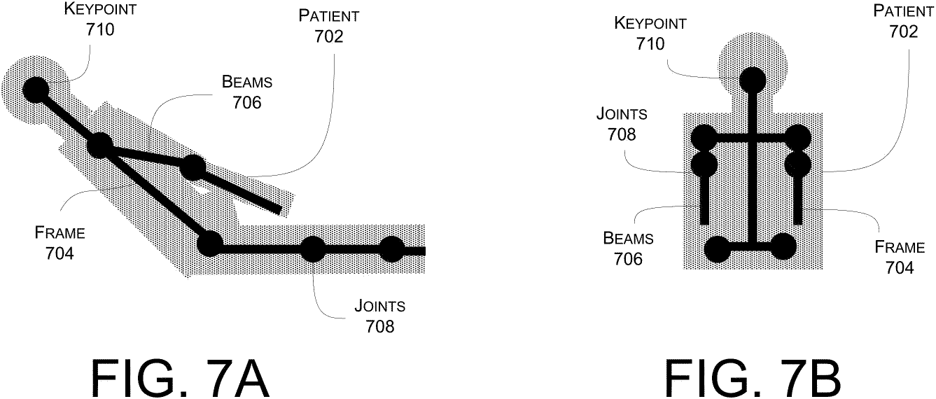

FIGS. 7A and 7B illustrate examples of a 3D patient pose determined by an imaging system. FIG. 7A illustrates the patient pose from a first direction and FIG. 7B illustrates the patient pose from a second direction.

As shown, an image object depicting a patient 702 is overlaid with a frame 704 of the patient 702. The frame 704 includes multiple beams 706 and multiple joints 708. The frame 704 is overlaid over at least a portion of the skeleton of the patient 702. The beams 706 may represent bones in the skeleton. The joints 708 represent flexible connection points between the bones of the skeleton, such as musculoskeletal joints or sockets. In addition, the frame 704 includes a keypoint 710 representing the head and/or face of the patient 702. In some examples, the imaging system generates frame 704 using a technique such as OpenPose.

The frame 704 may be generated based on one or more 2D images of the patient 702. In some examples, the imaging system infers the frame 704 based on one or more images captured from the second direction, and not the first direction. Because the frame 704 is defined three-dimensionally, the imaging system may use one or more techniques described herein to infer the 3D frame 704. In some implementations, one or more optical instruments are disposed in the field-of-view of the camera capturing the 2D image(s) and configured to generate one or more virtual images of the patient 702 from one or more different directions. The 2D image(s) may depict the virtual image(s). Based on the 2D image(s) and the virtual image(s), the imaging system may construct a 3D image of the patient 702. The imaging system may further generate the frame 704 based on the 3D image of the patient 702.

According to some implementations, the imaging system identifies multiple 2D images of the patient 702 that are captured at different focal lengths. The imaging system may identify the distance between various subjects captured in the images and the camera by identifying which focal lengths correspond to maximum sharpness in the image objects portraying the subjects. For example, the imaging system may identify the image among the images with the maximum sharpness of the feet of the patient 702, and may infer the distance between the camera and the feet of the patient 702 based on the focal length of the identified image. In some cases, the imaging system identifies one or more fiducial markers in the images and determines the 3D positions of various components of the patient 702 based on the fiducial marker(s). The imaging system may generate the frame 704 based on the relative distances between the components of the patient 702 and the camera.

In some cases, the imaging system may use non-imaging data to infer the 3D pose of the patient 702. According to some implementations, the imaging system may receive data indicating a pressure and/or weight on one or more load cells due to the patient 702 resting on a support structure including the load cell(s). The imaging system may use the pressure and/or weight as contextual information for inferring the 3D pose of the patient 702 based on the 2D image(s) of the patient 702. In some cases, the imaging system may receive data indicating a bed angle of the support structure and may use the bed angle as contextual information for inferring the 3D pose of the patient 702 based on the 2D image(s) of the patient 702.

In various implementations, the virtual image(s), the focal lengths, and/or the data from sensors of the support structure may further enhance the accuracy of the frame 704 generated by the imaging system. As shown in FIGS. 7A and 7B, the patient 702 has their legs extended toward the second direction. Based on the image object of the patient 702 in the second direction, the imaging system may be unable to determine whether the patient 702 has short legs or extended legs. However, based on the virtual image(s), the focal lengths, and/or the data from the sensors of the support structure, the imaging system may determine that the patient 702 has extended legs rather than short legs. Accordingly, the imaging system may be able to accurately identify the frame 704 from the first direction based on 2D images of the patient 702 from the second direction.

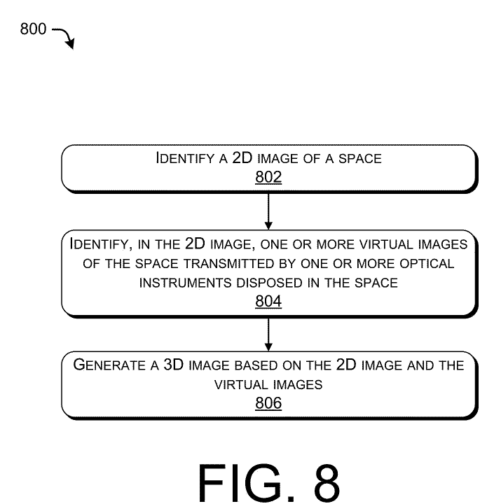

FIG. 8 illustrates an example process 800 for generating a 3D image of a space based on a 2D image of the space. The process 800 may be performed by an entity, such as the imaging system 136 described above, a processor, at least one computing device, or any combination thereof.

At 802, the entity identifies a 2D image of the space. In various implementations, the 2D image is captured by a 2D camera. The space, for example, is a 3D space including one or more 3D subjects. For instance, the space is a patient room in a clinical environment. The 2D image is captured from a first perspective. That is, the 2D image is captured by the 2D camera disposed in a particular position and disposed at a particular angle, such that the 2D camera captures the space from a first direction.

At 804, the entity identifies, in the 2D image, one or more virtual images of the space transmitted by one or more optical instruments disposed in the space. In various implementations, the optical instrument(s) are disposed in the space and configured to reflect and/or refract light in the space. For instance, the optical instrument(s) may include one or more mirrors and/or one or more lenses. Accordingly, an example virtual image may represent the space from a second perspective that is different than the first perspective. The second perspective may represent a second direction that extends from a given optical instrument into the space.

At 806, the entity generates the 3D image based on the 2D image and the virtual image(s). The 3D image may represent the space and/or one or more subjects disposed in the space. For example, the 3D image may depict an individual (e.g., a patient or care provider) disposed in the space. Because the 2D image is captured from the first perspective (or first direction) and the virtual image represents the space from the second perspective (or second direction), the entity may use the parallax of the 2D image and the virtual image to generate the 3D image. That is, the two perspectives of the space may enable the entity to identify depth information about the space, which may enable the entity to generate the 3D image.

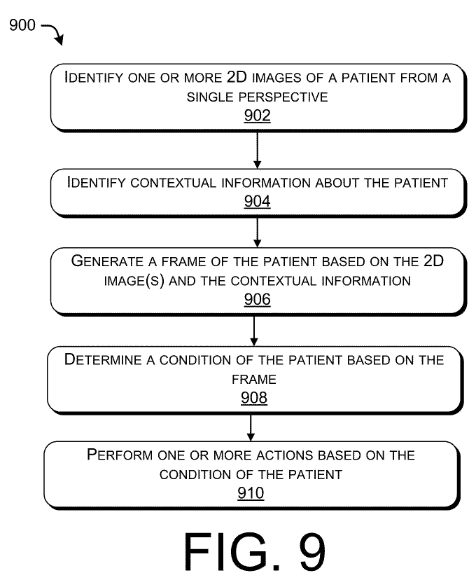

FIG. 9 illustrates an example process 900 for estimating a pose of a patient based on one or more 2D images of the patient. The process 900 may be performed by an entity, such as the imaging system 136 described above, a processor, at least one computing device, or any combination thereof.

At 902, the entity identifies one or more 2D images of the patient from a single perspective. For example, the 2D image(s) may be captured by a single 2D camera. In various implementations, the 2D camera captures the 2D image(s) from a single (e.g., a first) direction. In some cases, the 2D image(s) may depict a virtual image generated by an optical instrument, which may be configured to reflect and/or refract light from the patient. The virtual image may represent the patient from a different (e.g., a second) direction than the direction that the 2D camera captures the 2D image(s). Accordingly, a single 2D image may represent the patient from multiple directions. In some examples, the 2D camera captures multiple 2D images of the patient at different focal lengths. In some implementations, the 2D image(s) depict one or more fiducial markers in the space in which the patient is disposed. For example, the 2D image(s) depict a QR code and/or an ArUco code disposed on the patient or a device (e.g., a support structure supporting the patient).

At 904, the entity identifies contextual information about the patient. In some implementations, the contextual information provides further context about a position and/or orientation of the patient within the space. For instance, the contextual information may include a weight of the patient on a load cell of a support structure supporting the patient. In some implementations, the entity is communicatively coupled to the support structure and/or the load cell, and may receive a signal indicative of the weight from the support structure and/or the load cell. The weight of the patient may confirm that at least a portion of the patient is disposed above the load cell. For example, a non-zero weight on a load cell disposed in a footrest of the support structure may indicate that the patient’s feet are extended onto the foot rest. In some cases, the contextual information includes a temperature detected by a temperature sensor of the support structure, which may confirm whether the patient is in contact with the support structure. According to various implementations, the contextual information includes an angle of the support structure. For instance, the support structure may include a sensor that detects an angle of at least a portion of the support structure and which is communicatively coupled to the entity. If the entity determines that the support structure is disposed at a particular angle, and that the load cell and/or temperature sensor indicate that the patient is resting on the support structure, then the entity can infer that the patient is also disposed at the particular angle.

At 906, the entity generates a frame of the patient based on the 2D image(s) and the contextual information. In various implementations, the entity may analyze the 2D image(s) in order to determine the depth of the patient with respect to the 2D camera. For example, the entity may determine the distance between the 2D camera and the patient based on the parallax achieved by the 2D image and virtual image captured at different directions. In some instances, the entity may determine the distance between the 2D camera and the patient by modulating the focus of the 2D camera. In some cases, the 2D camera captures images while sweeping its lens focus from near to far, for example, and computes a histogram representing the contrast associated with the patient depicted in the images acquired. The measures are sorted for the maximal contrast achieved in the sweep and the focal position is looked up for that image. This focal position is known to correspond to a known depth of field for the imaging system, such that a focal length of the 2D camera associated with the highest sharpness image of the patient among the 2D images is determined. In some implementations, the entity determines the distance between the 2D camera and the patient based on the fiducial markers depicted in the 2D image(s).

In particular examples, the distance between the 2D camera and the head of the patient is determined, as well as the distance between the 2D camera and the feet of the patient. Without these distances, and with only a 2D image of the patient, the entity would not be able to distinguish between the patient being angled away from the 2D camera and the proportions of the patient. By knowing the distance of the head and feet of the patient, the entity can infer the angle of the patient’s body, which can enable the entity to determine the pose of the patient in 3D space.

At 908, the entity determines a condition of the patient based on the frame. For example, the entity may determine whether the patient has fallen out of the support structure based on the geometric center of mass of the patient and a bounding box representative of the support structure location within the frame indicating that the patient is laying down and is disposed on the floor if the center of mass is located outside the bounding box. In some cases, the entity may determine that the patient has slid down in the support structure and/or has a posture associated with a heightened risk of aspiration based on the frame.

At 910, the entity performs one or more actions based on the condition of the patient. According to various implementations, the entity generates an alert or report indicating that the patient requires assistance. The entity may further transmit the alert or report to an external device, such as a device associated with a care provider. Accordingly, the care provider can provide any necessary assistance to the patient. In some cases, the entity outputs a signal to the support structure to adjust the angle support structure based on the condition of the patient.

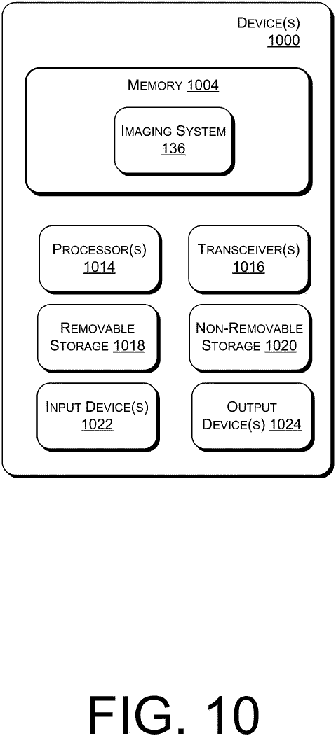

FIG. 10 illustrates at least one example device 1000 configured to enable and/or perform the some or all of the functionality discussed herein. Further, the device(s) 1000 can be implemented as one or more server computers 1002, a network element on a dedicated hardware, as a software instance running on a dedicated hardware, or as a virtualized function instantiated on an appropriate platform, such as a cloud infrastructure, and the like. It is to be understood in the context of this disclosure that the device(s) 1000 can be implemented as a single device or as a plurality of devices with components and data distributed among them.

As illustrated, the device(s) 1000 comprise a memory 1004. In various embodiments, the memory 1004 is volatile (including a component such as Random Access Memory (RAM)), non-volatile (including a component such as Read Only Memory (ROM), flash memory, etc.) or some combination of the two.

The memory 1004 may include various components, such as the imaging system 136. The imaging system 136 can include methods, threads, processes, applications, or any other sort of executable instructions. The imaging system 136 and various other elements stored in the memory 1004 can also include files and databases.

The memory 1004 may include various instructions (e.g., instructions in the imaging system 136), which can be executed by at least one processor 1014 to perform operations. In some embodiments, the processor(s) 1014 includes a Central Processing Unit (CPU), a Graphics Processing Unit (GPU), or both CPU and GPU, or other processing unit or component known in the art.

The device(s) 1000 can also include additional data storage devices (removable and/or non-removable) such as, for example, magnetic disks, optical disks, or tape. Such additional storage is illustrated in FIG. 10 by removable storage 1018 and non-removable storage 1020. Tangible computer-readable media can include volatile and nonvolatile, removable and non-removable media implemented in any method or technology for storage of information, such as computer readable instructions, data structures, program modules, or other data. The memory 1004, removable storage 1018, and non-removable storage 1020 are all examples of computer-readable storage media. Computer-readable storage media include, but are not limited to, RAM, ROM, EEPROM, flash memory or other memory technology, CD-ROM, Digital Versatile Discs (DVDs), Content-Addressable Memory (CAM), or other optical storage, magnetic cassettes, magnetic tape, magnetic disk storage or other magnetic storage devices, or any other medium which can be used to store the desired information and which can be accessed by the device(s) 1000. Any such tangible computer-readable media can be part of the device(s) 1000.

The device(s) 1000 also can include input device(s) 1022, such as a keypad, a cursor control, a touch-sensitive display, voice input device, a camera, etc., and output device(s) 1024 such as a display, speakers, printers, etc. These devices are well known in the art and need not be discussed at length here. In particular implementations, a user can provide input to the device(s) 1000 via a user interface associated with the input device(s) 1022 and/or the output device(s) 1024.

As illustrated in FIG. 10, the device(s) 1000 can also include one or more wired or wireless transceiver(s) 1016. For example, the transceiver(s) 1016 can include a Network Interface Card (NIC), a network adapter, a LAN adapter, or a physical, virtual, or logical address to connect to the various base stations or networks contemplated herein, for example, or the various user devices and servers. To increase throughput when exchanging wireless data, the transceiver(s) 1016 can utilize Multiple-Input/Multiple-Output (MIMO) technology. The transceiver(s) 1016 can include any sort of wireless transceivers capable of engaging in wireless, Radio Frequency (RF) communication. The transceiver(s) 1016 can also include other wireless modems, such as a modem for engaging in Wi-Fi, WiMAX, Bluetooth, or infrared communication. In some implementations, the transceiver(s) 1016 can be used to communicate between various functions, components, modules, or the like, that are comprised in the device(s) 1000.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

Although the subject matter has been described in language specific to structural features and/or methodological acts, it is to be understood that the subject matter defined in the appended claims is not necessarily limited to the specific features or acts described.

### Example Clauses

1. An imaging system, including: an optical camera configured to capture a two-dimensional (2D) image of a three-dimensional (3D) space; an optical instrument disposed in the 3D space and configured to refract and/or reflect light; a processor communicatively coupled to the optical camera; and memory storing instructions that, when executed by the processor, cause the processor to perform operations including: receiving the 2D image of the 3D space from the optical camera; identifying, in the 2D image, a virtual image of the 3D space generated by the optical instrument refracting and/or reflecting the light; identifying, in the 2D image, a first object depicting a subject disposed in the 3D space from a first direction extending from the optical camera to the subject; identifying, in the virtual image, a second object depicting the subject disposed in the 3D space from a second direction extending from the optical camera to the subject via the optical instrument, the second direction being different than the first direction; and generating a 3D image depicting the subject based on the first object and the second object; or determining a location of the subject in the 3D space based on the first object and the second object.

2. The imaging system of clause 1, wherein the optical instrument includes at least one of a mirror or a one lens.

3. The imaging system of clause 1 or 2, wherein the optical instrument includes a convex mirror.

4. The imaging system of any one of clauses 1 to 3, wherein the optical instrument is mounted on a wall or a ceiling of the 3D space.

5. The imaging system of any one of clauses 1 to 4, wherein: the optical instrument includes one or more fiducial markers on a surface of the optical instrument; the 2D image depicts a third object depicting the one or more fiducial markers overlaid on the virtual image; and the location is determined based on the third object depicting the one or more fiducial markers.

6. The imaging system of clause 5, wherein generating the 3D image based on the third object depicting the one or more fiducial markers includes: determining a distance between the optical camera and the optical instrument based on a relative size of the one or more fiducial markers in the 2D image with respect to a known size of the one or more fiducial markers; determining an orientation of the surface of the optical instrument based on a relative shape of the one or more fiducial markers in the 2D image with respect to a known shape of the one or more fiducial markers; and generating the 3D image based on the distance and the orientation.

7. The imaging system of clause 5 or 6, wherein determining the location based on the third object depicting the one or more fiducial markers includes: determining a distance between the optical camera and the optical instrument based on a relative size of the one or more fiducial markers in the 2D image with respect to a known size of the one or more fiducial markers; determining an orientation of the surface of the optical instrument based on a relative shape of the one or more fiducial markers in the 2D image with respect to a known shape of the one or more fiducial markers; and determining the location based on the distance and the orientation.

8. The imaging system of any one of clauses 5 to 7, wherein the optical camera includes an infrared (IR) camera, the 2D image includes an IR image, and the one or more fiducial markers include an IR pattern disposed on the surface of the optical instrument.

9. The imaging system of any one of clauses 5 to 8, wherein the one or more fiducial markers include an ArUco code.

10. The imaging system of any one of clauses 1 to 9, wherein generating the 3D image includes generating a point cloud of the subject.

11. The imaging system of any one of clauses 1 to 10, further including: a transceiver communicatively coupled to the processor and configured to transmit a control signal to a robotic device, wherein the operations further include generating the control signal based on the 3D image.

12. The imaging system of any one of clauses 1 to 11, wherein: the 3D space includes an operating room, a procedure room, an exam room, or a patient room, and the subject includes a medical device, a patient, or a care provider.

13. The imaging system of any one of clauses 1 to 12, the virtual image being a first virtual image, the optical instrument being a first optical instrument, wherein: the operations further include: identifying, in the 2D image, a second virtual image of the 3D space generated by a second optical instrument refracting and/or reflecting the light; and identifying, in the second virtual image, a third object depicting the subject disposed in the 3D space from a third direction extending from the optical camera to the subject via the second optical instrument, the third direction being different than the first direction and the second direction, and the 3D image is generated based on the third object, or the location is determined based on the third obj ect.

14. The imaging system of any one of clauses 1 to 13, the 2D image being a first 2D image, the virtual image being a first virtual image, the subject being a first subject, wherein: the optical instrument further includes an actuator; the operations further include: causing the actuator to move the optical instrument from a first position to a second position; receiving a second 2D image of the 3D space from the optical camera when the optical instrument is in the second position; identifying, in the second 2D image, a second virtual image generated by the optical instrument refracting and/or reflecting the light; identifying, in the second 2D image, a third object depicting a second subject disposed in the 3D space from third first direction extending from the optical camera to the subject; and identifying, in the second virtual image, a fourth object depicting the second subject disposed in the 3D space from a fourth direction extending from the optical camera to the second subject via the optical instrument in the second position, wherein the fourth direction is different than the third direction, the 3D image is generated based on the third object and the fourth object, and the 3D image depicts the second subject.

15. The imaging system of any one of clauses 1 to 14, wherein: the subject includes an individual; and the operations further include determining a pose of the individual based on the 3D image or the location.

16. The imaging system of clause 15, further including: a transceiver configured to receive sensor data from a support structure of the individual, the sensor data indicating a weight of the individual on a surface of the support structure; wherein the pose of the individual is further determined based on the sensor data.

17. The imaging system of any one of clauses 1 to 16, the subject being a first subject, wherein: the operations further include identifying, in the virtual image, a third object depicting one or more fiducial markers disposed on the first subject or a second subject in the 3D space, and the location is determined based on the third object.

18. The imaging system of clause 17, wherein the one or more fiducial markers are disposed on a support structure or a medical device.

19. The imaging system of clause 17 or 18, wherein the one or more fiducial markers are displayed on a screen of the first subject or the second subject.

20. The imaging system of any one of clauses 17 to 19, wherein the one or more fiducial markers include at least one of an ArUco code or a QR code.

21. A computing system, including: a processor; and memory storing instructions that, when executed by the processor, cause the processor to perform operations including: identifying a 2D image of a 3D space; identifying, in the 2D image, a virtual image generated by an optical instrument refracting and/or reflecting light in the 3D space; identifying, in the 2D image, a first object depicting a subject disposed in the 3D space from a first direction; identifying, in the virtual image, a second object depicting the subject disposed in the 3D space from a second direction, the second direction being different than the first direction; and generating a 3D image of the subject based on the first object and the second object.

22. The computing system of clause 21, wherein: the subject includes an individual; and the operations further include determining a pose of the individual based on the 3D image.

23. The computing system of clause 22, wherein the operations further include: determining a condition of the individual based on the pose, the condition including at least one of a bed exit, a fall, or a posture associated with aspiration.

24. The computing system of any one of clauses 21 to 23, the subject being a first subject, wherein: the operations further include identifying, in the virtual image, a third object depicting one or more fiducial markers disposed on the first subject or a second subject in the 3D space, and generating the 3D image based on the third object.

25. The computing system of any one of clauses 21 to 24, wherein: the one or more fiducial markers are disposed on a support structure or a medical device; or the one or more fiducial markers are displayed on a screen of the first subject or the second subject.

26. A method, including: capturing, by a camera, a first image of a subject at a first focal length; capturing, by the camera, a second image of the subject at a second focal length; identifying a first sharpness of an object representing the subject in the first image; identifying a second sharpness of an object representing the subject in the second image; determining that the first sharpness is greater than the second sharpness; and based on determining that the first sharpness is greater than the second sharpness, determining a distance between the camera and the subject based on the first focal length.

27. The method of clause 26, further including: generating a 3D image of the subject based on the distance between the camera and the subject.

28. The method of clause 26 or 27, wherein the subject includes at least a portion of an individual, the method further including: determining a pose of the individual based on the distance between the camera and the subject.

29. A computing system, including: a processor; and memory storing instructions that, when executed by the processor, cause the processor to perform operations including: identifying or more images of an individual resting on a support surface, the one or more images being from a direction; identifying contextual information about the patient, the contextual information including a weight, position, or temperature of the individual resting on the support surface; generating a frame of the individual based on the one or more images and the contextual information; determining a condition of the individual based on the frame; and performing one or more actions based on the condition of the individual.

30. The computing system of clause 29, the direction being a first direction, wherein: the operations further include: identifying, based on the one or more images, a first object representing the individual from the first direction; identifying a virtual image of the individual in the one or more images; identifying, based on the virtual image, a second object representing the individual from a second direction that is different than the first direction; and generating a 3D image of the individual based on the first object and the second object, and generating the frame is based on the 3D image.

31. The computing system of clause 29 or 30, wherein: the one or more images include a first image of the individual captured by a camera at a first focal length and a second image of the individual captured by the camera at a second focal length, the operations further include: determining that a first sharpness of the first image exceeds a second sharpness of the second image; determining a distance between the camera and the individual based on the first focal length, and generating the frame is based on the distance between the camera and the individual.

### Conclusion

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

Although the subject matter has been described in language specific to structural features and/or methodological acts, it is to be understood that the subject matter defined in the appended claims is not necessarily limited to the specific features or acts described.

What is claimed is:

1. An imaging system, comprising:
an optical camera configured to capture a two-dimensional (2D) image of a three-dimensional (3D) space;
an optical instrument disposed in the 3D space and configured to refract and/or reflect light;
a processor communicatively coupled to the optical camera; and
memory storing instructions that, when executed by the processor, cause the processor to perform operations comprising:
receiving the 2D image of the 3D space from the optical camera;
identifying, in the 2D image, a virtual image of the 3D space generated by the optical instrument refracting and/or reflecting the light;
identifying, in the 2D image, a first object depicting a subject disposed in the 3D space from a first direction extending from the optical camera to the subject;
identifying, in the virtual image, a second object depicting the subject disposed in the 3D space from a second direction extending from the optical camera to the subject via the optical instrument, the second direction being different than the first direction; and
generating a 3D image depicting the subject based on the first object and the second object; or
determining a location of the subject in the 3D space based on the first object and the second object.

2. The imaging system of claim 1, wherein the optical instrument comprises at least one of a mirror or a lens.

3. The imaging system of claim 1, wherein:
the optical instrument comprises one or more fiducial markers on a surface of the optical instrument;
the 2D image depicts a third object depicting the one or more fiducial markers overlaid on the virtual image; and
the location is determined based on the third object depicting the one or more fiducial markers.

4. The imaging system of claim 3, wherein generating the 3D image based on the third object depicting the one or more fiducial markers comprises:
determining a distance between the optical camera and the optical instrument based on a relative size of the one or more fiducial markers in the 2D image with respect to a known size of the one or more fiducial markers;
determining an orientation of the surface of the optical instrument based on a relative shape of the one or more fiducial markers in the 2D image with respect to a known shape of the one or more fiducial markers; and
generating the 3D image based on the distance and the orientation.

5. The imaging system of claim 3, wherein determining the location based on the third object depicting the one or more fiducial markers comprises:
determining a distance between the optical camera and the optical instrument based on a relative size of the one or more fiducial markers in the 2D image with respect to a known size of the one or more fiducial markers;
determining an orientation of the surface of the optical instrument based on a relative shape of the one or more fiducial markers in the 2D image with respect to a known shape of the one or more fiducial markers; and
determining the location based on the distance and the orientation.

6. The imaging system of claim 3, wherein the optical camera comprises an infrared (IR) camera, the 2D image comprises an IR image, and the one or more fiducial markers comprise an IR pattern disposed on the surface of the optical instrument.

7. The imaging system of claim 3, wherein the one or more fiducial markers comprise an ArUco code.

8. The imaging system of claim 1, further comprising:
a transceiver communicatively coupled to the processor and configured to transmit a control signal to a robotic device,
wherein the operations further comprise generating the control signal based on the 3D image.

9. The imaging system of claim 1, the virtual image being a first virtual image, the optical instrument being a first optical instrument, wherein:
the operations further comprise:
identifying, in the 2D image, a second virtual image of the 3D space generated by a second optical instrument refracting and/or reflecting the light; and
identifying, in the second virtual image, a third object depicting the subject disposed in the 3D space from a third direction extending from the optical camera to the subject via the second optical instrument, the third direction being different than the first direction and the second direction, and
the 3D image is generated based on the third object, or
the location is determined based on the third object.

10. The imaging system of claim 1, the 2D image being a first 2D image, the virtual image being a first virtual image, the subject being a first subject, wherein:
the optical instrument further comprises an actuator; and
the operations further comprise:
causing the actuator to move the optical instrument from a first position to a second position;
receiving a second 2D image of the 3D space from the optical camera when the optical instrument is in the second position;
identifying, in the second 2D image, a second virtual image generated by the optical instrument refracting and/or reflecting the light;
identifying, in the second 2D image, a third object depicting a second subject disposed in the 3D space from third first direction extending from the optical camera to the subject; and
identifying, in the second virtual image, a fourth object depicting the second subject disposed in the 3D space from a fourth direction extending from the optical camera to the second subject via the optical instrument in the second position, wherein
the fourth direction is different than the third direction,
the 3D image is generated based on the third object and the fourth object, and
the 3D image depicts the second subject.

11. The imaging system of claim 1, further comprising:
a transceiver configured to receive sensor data from a support structure of the individual, the sensor data indicating a weight of the individual on a surface of the support structure,
wherein:
the subject comprises an individual; and
the operations further comprise determining a pose of the individual based on:
the sensor data; and
the 3D image or the location.

12. The imaging system of claim 1, the subject being a first subject, wherein:
the operations further comprise identifying, in the virtual image, a third object depicting one or more fiducial markers disposed on the first subject or a second subject in the 3D space, and
the location is determined based on the third object.

13. A computing system, comprising:
a processor; and
memory storing instructions that, when executed by the processor, cause the processor to perform operations comprising:
identifying a 2D image of a 3D space;
identifying, in the 2D image, a virtual image generated by an optical instrument refracting and/or reflecting light in the 3D space;
identifying, in the 2D image, a first object depicting a subject disposed in the 3D space from a first direction;
identifying, in the virtual image, a second object depicting the subject disposed in the 3D space from a second direction, the second direction being different than the first direction; and
generating a 3D image of the subject based on the first object and the second obj ect.

14. The computing system of claim 13, wherein:
the subject comprises an individual; and
the operations further comprise determining a pose of the individual based on the 3D image.

15. The computing system of claim 14, wherein the operations further comprise:
determining a condition of the individual based on the pose, the condition comprising at least one of a bed exit, a fall, or a posture associated with aspiration.

16. The computing system of claim 13, the subject being a first subject, wherein:
the operations further comprise identifying, in the virtual image, a third object depicting one or more fiducial markers disposed on the first subject or a second subject in the 3D space, and
generating the 3D image based on the third object.

17. The computing system of claim 13, wherein:
the one or more fiducial markers are disposed on a support structure or a medical device; or
the one or more fiducial markers are displayed on a screen of the first subject or the second subject.

18. A method, comprising:
capturing, by a camera, a first image of a subject at a first focal length;
capturing, by the camera, a second image of the subject at a second focal length;
identifying a first sharpness of an object representing the subject in the first image;
identifying a second sharpness of an object representing the subject in the second image;
determining that the first sharpness is greater than the second sharpness; and
based on determining that the first sharpness is greater than the second sharpness, determining a distance between the camera and the subject based on the first focal length.

19. The method of claim 18, further comprising:
generating a 3D image of the subject based on the distance between the camera and the subj ect.

20. The method of claim 18, wherein the subject comprises at least a portion of an individual, the method further comprising:
determining a pose of the individual based on the distance between the camera and the subj ect.
